(19) United States
(12) Patent Application Publication
(10) Pub. No.: US 2025/0184927 A1
(43) Pub. Date: Jun. 5, 2025

(54) TIMING ADVANCE TIMER HANDLING FOR MULTI-TIMING ADVANCE OPERATION FOR MULTI-TRANSMIT AND RECEIVE POINTS

(71) Applicant: QUALCOMM Incorporated, San Diego, CA (US)

(72) Inventors: Fang YUAN, Beijing (CN); Yan ZHOU, San Diego, CA (US); Tao LUO, San Diego, CA (US)

(21) Appl. No.: 18/840,283

(22) PCT Filed: Apr. 14, 2022
(86) PCT No.: PCT/CN2022/086807

§ 371 Date: Aug. 21, 2024

(51) Int. Cl. H04W 56/00; H04L 1/1822

(52) U.S. Cl. CPC H04W 56/001; H04L 1/1822

(57) ABSTRACT

A wireless communication device releases, in association with a serving cell that is a special cell (SpCell) and has at least two timing advance groups (TAGs) with one time alignment timer (timeAlignmentTimer) of the at least two TAGs being expired, at least one of: a physical uplink control channel (PUCCH), a physical uplink shared channel (PUSCH), or a sounding reference signal (SRS) for at least one of cells or transmission and reception points (TRPs) that share a TAG associated with the one timeAlignmentTimer that is expired, or releases, in association with the serving cell that is the SpCell and has the at least two TAGs with two respective timeAlignmentTimers of the at least two TAGs being expired, the at least one of: the PUCCH, the PUSCH, or the SRS for all cells or TRPs that are in a same cell group as the SpCell.

### TECHNICAL FIELD

The technology discussed below relates generally to wireless communication systems and, more particularly, to timing advance timer handling for multi-timing advance operation for multi-transmit and receive points.

### INTRODUCTION

A plurality of user equipment (UE) may be located at various distances from a network access node (e.g., a base station, a gNB) at any given time. Because the distances vary, the propagation delay (which is proportional to distance) between the network access node and each of the UEs correspondingly varies. All UEs may be synchronized in time with a universal time standard (e.g., a universal time derived from a global navigation satellite system); however, the variation in propagation delay causes uplink transmissions from respective UEs to arrive at the base station at different times. Timing advance may be used to control an uplink transmission timing of an individual UE.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

In one example, a user equipment (UE) configured for wireless communication is disclosed. The UE includes a processor, and a memory coupled to the processor. In the example, the processor and the memory are configured to at least one of: release, in association with a serving cell that is a special cell (SpCell) and has at least two timing advance groups (TAGs) with one time alignment timer (timeAlignmentTimer) of the at least two TAGs being expired, at least one of: a physical uplink control channel (PUCCH), a physical uplink shared channel (PUSCH), or a sounding reference signal (SRS) for at least one of cells or transmission and reception points (TRPs) that share a TAG associated with the one timeAlignmentTimer that is expired; or release, in association with the serving cell that is the SpCell and has the at least two TAGs with two respective timeAlignmentTimers of the at least two TAGs being expired, the at least one of: the PUCCH, the PUSCH, or the SRS for all cells or TRPs that are in a same cell group as the SpCell.

In another example, a method of wireless communication at a user equipment (UE) is disclosed. The method includes at least one of: releasing, in association with a serving cell that is a special cell (SpCell) and has at least two timing advance groups (TAGs) with one time alignment timer (timeAlignmentTimer) of the at least two TAGs being expired, at least one of: a physical uplink control channel (PUCCH), a physical uplink shared channel (PUSCH), or a sounding reference signal (SRS) for at least one of cells or transmission and reception points (TRPs) that share a TAG associated with the one timeAlignmentTimer that is expired; or releasing, in association with the serving cell that is the SpCell and has the at least two TAGs with two respective timeAlignmentTimers of the at least two TAGs being expired, the at least one of: the PUCCH, the PUSCH, or the SRS for all cells or TRPs that are in a same cell group as the SpCell.

In still another example, an apparatus for wireless communication is disclosed. The apparatus includes at least one of: means for releasing, in association with a serving cell that is a special cell (SpCell) and has at least two timing advance groups (TAGs) with one time alignment timer (timeAlignmentTimer) of the at least two TAGs being expired, at least one of: a physical uplink control channel (PUCCH), a physical uplink shared channel (PUSCH), or a sounding reference signal (SRS) for at least one of cells or transmission and reception points (TRPs) that share a TAG associated with the one timeAlignmentTimer that is expired; or means for releasing, in association with the serving cell that is the SpCell and has the at least two TAGs with two respective timeAlignmentTimers of the at least two TAGs being expired, the at least one of: the PUCCH, the PUSCH, or the SRS for all cells or TRPs that are in a same cell group as the SpCell.

These and other aspects will become more fully understood upon a review of the detailed description, which follows. Other aspects, features, and examples will become apparent to those of ordinary skill in the art upon reviewing the following description of specific exemplary aspects in conjunction with the accompanying figures. While features may be discussed relative to certain examples and figures below, all examples can include one or more of the advantageous features discussed herein. In other words, while one or more examples may be discussed as having certain advantageous features, one or more of such features may also be used in accordance with the various examples discussed herein. Similarly, while examples may be discussed below as device, system, or method examples, it should be understood that such examples can be implemented in various devices, systems, and methods.

### BRIEF DESCRIPTION OF THE DRAWINGS

FIG. 1 is a schematic illustration of a wireless communication system according to some aspects of the disclosure.

FIG. 2 is a schematic illustration of an example of a radio access network (RAN) according to some aspects of the disclosure.

FIG. 3 is an expanded view of an exemplary subframe, showing an orthogonal frequency divisional multiplexing (OFDM) resource grid according to some aspects of the disclosure.

FIG. 4 is a block diagram illustrating protocol stacks that may be implemented in a user plane and a control plane of various wireless communication devices, such as the various wireless communication devices shown and described above in connection with the examples of FIGS. 1 and/or 2.

FIGS. 5A and 5B are schematic diagrams illustrating aspects of timing advance according to some aspects of the disclosure.

FIGS. 6A, 6B, and 6C are three versions, or perspectives, of a wireless communication network in which a user equipment (UE) is in a multi-transmission and reception point (multi-TRP) configuration with a first TRP and a second TRP according to some aspects of the disclosure.

FIG. 7 is a block diagram illustrating an example of a hardware implementation of a wireless communication device (e.g., a UE) employing a processing system according to some aspects of the disclosure.

FIG. 8 is a flow chart illustrating an exemplary process at user equipment according to some aspects of the disclosure.

FIG. 9 is a flow chart illustrating an exemplary process at user equipment according to some aspects of the disclosure.

FIG. 10 is a flow chart illustrating an exemplary process at user equipment according to some aspects of the disclosure.

FIG. 11 is a flow chart illustrating an exemplary process at user equipment according to some aspects of the disclosure.

FIG. 12 is a flow chart illustrating an exemplary process at user equipment according to some aspects of the disclosure.

FIG. 13 is a flow chart illustrating an exemplary process at user equipment according to some aspects of the disclosure.

FIG. 14 is a flow chart illustrating an exemplary process at user equipment according to some aspects of the disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some examples, well known structures and components are shown in block diagram form in order to avoid obscuring such concepts.

While aspects and examples are described in this application by illustration to some examples, those skilled in the art will understand that additional implementations and use cases may come about in many different arrangements and scenarios. Innovations described herein may be implemented across many differing platform types, devices, systems, shapes, sizes, and packaging arrangements. For example, aspects and/or uses may come about via integrated chip examples and other non-module-component based devices (e.g., end-user devices, vehicles, communication devices, computing devices, industrial equipment, retail/purchasing devices, medical devices, AI-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described examples. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, disaggregated arrangements (e.g., base station and/or user equipment (UE)), end-user devices, etc. of varying sizes, shapes, and constitution.

Described herein are methods and apparatus directed toward releasing various channels and signals and flushing various buffers in connection with timing advance operations practiced at a UE. The UE may be operationally coupled to multiple transmission and reception points (TRPs). Multiple timing advance commands and time alignment timers, corresponding to the multiple TRPs and pluralities of timing alignment groups (TAGs) may be received and utilized by a given UE while the given UE is communicating with the multiple TRPs simultaneously or substantially simultaneously.

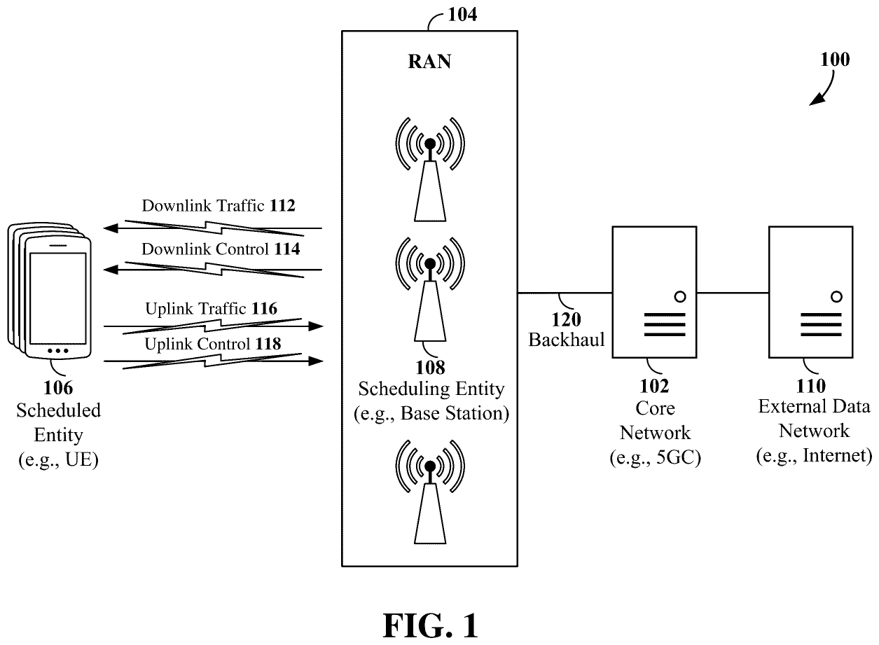

The various concepts presented throughout this disclosure may be implemented across a broad variety of telecommunication systems, network architectures, and communication standards. Referring now to FIG. 1, as an illustrative example without limitation, various aspects of the present disclosure are illustrated with reference to a wireless communication system 100. The wireless communication system 100 includes three interacting domains: a core network 102, a radio access network (RAN) 104, and a user equipment (UE) 106. By virtue of the wireless communication system 100, the UE 106 may be enabled to carry out data communication with an external data network 110, such as (but not limited to) the Internet.

The RAN 104 may implement any suitable wireless communication technology or technologies to provide radio access to the UE 106. As one example, the RAN 104 may operate according to 3rd Generation Partnership Project (3GPP) New Radio (NR) specifications, often referred to as 5G. As another example, the RAN 104 may operate under a hybrid of 5G NR and Evolved Universal Terrestrial Radio Access Network (eUTRAN) standards, often referred to as Long Term Evolution (LTE). The 3GPP refers to this hybrid RAN as a next-generation RAN, or NG-RAN. Of course, many other examples may be utilized within the scope of the present disclosure.

As illustrated, the RAN 104 includes a plurality of base stations 108. Broadly, a base station is a network element in a radio access network responsible for radio transmission and reception in one or more cells to or from a UE. In different technologies, standards, or contexts, a base station may variously be referred to by those skilled in the art as a base transceiver station (BTS), a radio base station, a radio transceiver, a transceiver function, a basic service set (BSS), an extended service set (ESS), an access point (AP), a Node B (NB), an eNode B (eNB), a gNode B (gNB), a transmission and reception point (TRP), or some other suitable terminology. In some examples, a base station may include two or more TRPs that may be collocated or non-collocated. Each TRP may communicate on the same or different carrier frequency within the same or different frequency band. In examples where the RAN 104 operates according to both the LTE and 5G NR standards, one of the base stations may be an LTE base station, while another base station may be a 5G NR base station.

The RAN 104 is further illustrated supporting wireless communication for multiple mobile apparatuses. A mobile apparatus may be referred to as user equipment (UE) in 3GPP standards, but may also be referred to by those skilled in the art as a mobile station (MS), a subscriber station, a mobile unit, a subscriber unit, a wireless unit, a remote unit, a mobile device, a wireless device, a wireless communication device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus (e.g., a mobile apparatus) that provides a user with access to network services.

Within the present disclosure, a “mobile” apparatus need not necessarily have a capability to move and may be stationary. The term mobile apparatus or mobile device broadly refers to a diverse array of devices and technologies. UEs may include a number of hardware structural components sized, shaped, and arranged to help in communication; such components can include antennas, antenna arrays, RF-chains, amplifiers, one or more processors, etc. electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of Things” (IoT).

A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc., an industrial automation and enterprise device, a logistics controller, and/or agricultural equipment, etc. Still further, a mobile apparatus may provide for connected medicine or telemedicine support, e.g., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

Wireless communication between the RAN 104 and the UE 106 may be described as utilizing an air interface. Transmissions over the air interface from a base station (e.g., base station 108) to one or more UEs (e.g., similar to UE 106) may be referred to as downlink (DL) transmission. In accordance with certain aspects of the present disclosure, the term downlink may refer to a point-to-multipoint transmission originating at a base station (e.g., base station 108). Another way to describe this scheme may be to use the term broadcast channel multiplexing. Transmissions from a UE (e.g., UE 106) to a base station (e.g., base station 108) may be referred to as uplink (UL) transmissions. In accordance with further aspects of the present disclosure, the term uplink may refer to a point-to-point transmission originating at a UE (e.g., UE 106).

In some examples, access to the air interface may be scheduled, wherein a scheduling entity (e.g., a base station 108) allocates resources for communication among some or all devices and equipment within its service area or cell. Within the present disclosure, as discussed further below, the scheduling entity may be responsible for scheduling, assigning, reconfiguring, and releasing resources for one or more scheduled entities (e.g., UEs 106). That is, for scheduled communication, a plurality of UEs 106, which may be scheduled entities, may utilize resources allocated by the scheduling entity 108.

Base stations 108 are not the only entities that may function as scheduling entities. That is, in some examples, a UE may function as a scheduling entity, scheduling resources for one or more scheduled entities (e.g., one or more other UEs). For example, UEs may communicate directly with other UEs in a peer-to-peer or device-to-device fashion and/or in a relay configuration.

As illustrated in FIG. 1, a scheduling entity 108 may broadcast downlink traffic 112 to one or more scheduled entities (e.g., one or more UEs 106). Broadly, the scheduling entity 108 is a node or device responsible for scheduling traffic in a wireless communication network, including the downlink traffic 112 and, in some examples, uplink traffic 116 from one or more scheduled entities (e.g., one or more UEs 106) to the scheduling entity 108. On the other hand, the scheduled entity (e.g., a UE 106) is a node or device that receives downlink control information 114, including but not limited to scheduling information (e.g., a grant), synchronization or timing information, or other control information from another entity in the wireless communication network such as the scheduling entity 108. The scheduled entity 106 may further transmit uplink control information 118, including but not limited to a scheduling request or feedback information, or other control information to the scheduling entity 108.

In addition, the uplink and/or downlink control 118 and/or 118 information and/or uplink and/or downlink traffic 116 and/or 112 may be transmitted on a waveform that may be time-divided into frames, subframes, slots, and/or symbols. As used herein, a symbol may refer to a unit of time that, in an orthogonal frequency division multiplexed (OFDM) waveform, carries one resource element (RE) per sub-carrier. A slot may carry 7 or 14 OFDM symbols. A subframe may refer to a duration of 1 ms. Multiple subframes or slots may be grouped together to form a single frame or radio frame. Within the present disclosure, a frame may refer to a predetermined duration (e.g., 10 ms) for wireless transmissions, with each frame consisting of, for example, 10 subframes of 1 ms each. Of course, these definitions are not required, and any suitable scheme for organizing waveforms may be utilized, and various time divisions of the waveform may have any suitable duration.

In general, base stations 108 may include a backhaul interface for communication with a backhaul portion 120 of the wireless communication system 100. The backhaul portion 120 may provide a link between a base station 108 and the core network 102. Further, in some examples, a backhaul network may provide interconnection between the respective base stations 108. Various types of backhaul interfaces may be employed, such as a direct physical connection, a virtual network, or the like using any suitable transport network.

The core network 102 may be a part of the wireless communication system 100 and may be independent of the radio access technology used in the RAN 104. In some examples, the core network 102 may be configured according to 5G standards (e.g., 5G core (5GC)). In other examples, the core network 102 may be configured according to a 4G evolved packet core (EPC), or any other suitable standard or configuration.

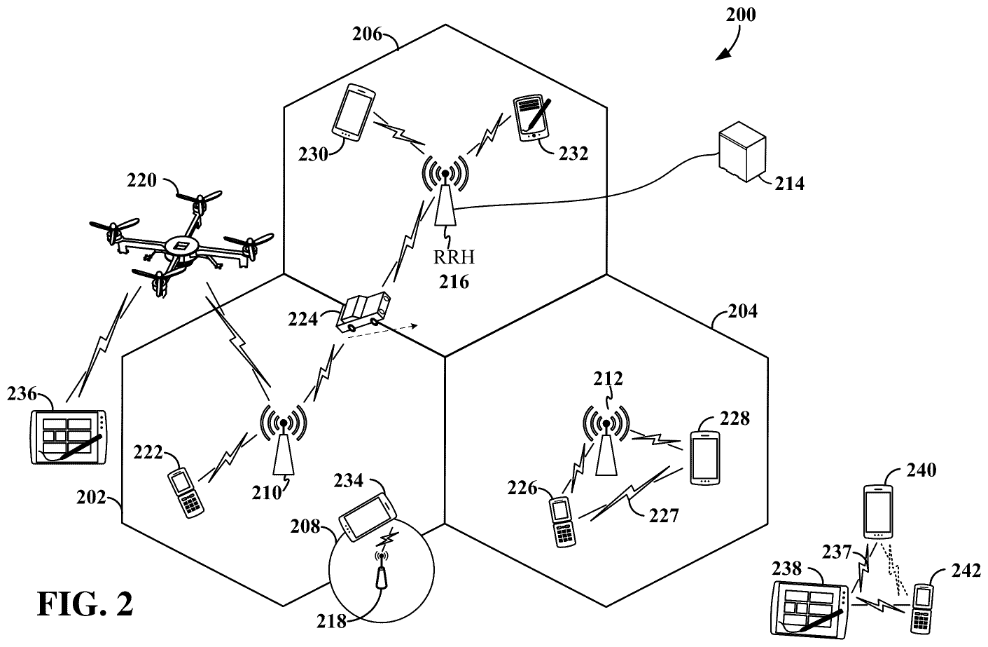

Referring now to FIG. 2, as an illustrative example without limitation, a schematic illustration of a radio access network (RAN) 200 according to some aspects of the present disclosure is provided. In some examples, the RAN 200 may be the same as the RAN 104 described above and illustrated in FIG. 1.

The geographic region covered by the RAN 200 may be divided into a number of cellular regions (cells) that can be uniquely identified by a user equipment (UE) based on an identification broadcasted over a geographical area from one access point or base station. FIG. 2 illustrates cells 202, 204, 206, and 208, each of which may include one or more sectors (not shown). A sector is a sub-area of a cell. All sectors within one cell are served by the same base station. A radio link within a sector can be identified by a single logical identification belonging to that sector. In a cell that is divided into sectors, the multiple sectors within a cell can be formed by groups of antennas with each antenna responsible for communication with UEs in a portion of the cell.

Various base station arrangements can be utilized. For example, in FIG. 2, two base stations, base station 210 and base station 212 are shown in cells 202 and 204. A third base station, base station 214 is shown controlling a remote radio head (RRH) 216 in cell 206. That is, a base station can have an integrated antenna or can be connected to an antenna or RRH 216 by feeder cables. In the illustrated example, cells 202, 204, and 206 may be referred to as macrocells, as the base stations 210, 212, and 214 support cells having a large size. Further, a base station 218 is shown in the cell 208, which may overlap with one or more macrocells. In this example, the cell 208 may be referred to as a small cell (e.g., a small cell, a microcell, picocell, femtocell, home base station, home Node B, home eNode B, etc.), as the base station 218 supports a cell having a relatively small size. Cell sizing can be done according to system design as well as component constraints.

It is to be understood that the RAN 200 may include any number of wireless base stations and cells. Further, a relay node may be deployed to extend the size or coverage area of a given cell. The base stations 210, 212, 214, 218 provide wireless access points to a core network for any number of mobile apparatuses. In some examples, the base stations 210, 212, 214, and/or 218 may be the same as or similar to the scheduling entity 108 described above and illustrated in FIG. 1.

FIG. 2 further includes an unmanned aerial vehicle (UAV) 220, which may be a drone or quadcopter. The UAV 220 may be configured to function as a base station, or more specifically as a mobile base station. That is, in some examples, a cell may not necessarily be stationary, and the geographic area of the cell may move according to the location of a mobile base station, such as the UAV 220.

Within the RAN 200, the cells may include UEs that may be in communication with one or more sectors of each cell. Further, each base station 210, 212, 214, 218, and 220 may be configured to provide an access point to a core network 102 (see FIG. 1) for all the UEs in the respective cells. For example, UEs 222 and 224 may be in communication with base station 210; UEs 226 and 228 may be in communication with base station 212; UEs 230 and 232 may be in communication with base station 214 by way of RRH 216; UE 234 may be in communication with base station 218; and UE 236 may be in communication with mobile base station 220. In some examples, the UEs 222, 224, 226, 228, 230, 232, 234, 236, 238, 240, and/or 242 may be the same as or similar to the UE/scheduled entity 106 described above and illustrated in FIG. 1. In some examples, the UAV 220 (e.g., the quadcopter) can be a mobile network node and may be configured to function as a UE. For example, the UAV 220 may operate within cell 202 by communicating with base station 210.

In a further aspect of the RAN 200, sidelink signals may be used between UEs without necessarily relying on scheduling or control information from a base station. Sidelink communication may be utilized, for example, in a device-to-device (D2D) network, peer-to-peer (P2P) network, vehicle-to-vehicle (V2V) network, vehicle-to-everything (V2X) network, and/or other suitable sidelink network. For example, two or more UEs (e.g., UEs 238, 240, and 242) may communicate with each other using sidelink signals 237 without relaying that communication through a base station. In some examples, the UEs 238, 240, and 242 may each function as a scheduling entity or transmitting sidelink device and/or a scheduled entity or a receiving sidelink device to schedule resources and communicate sidelink signals 237 therebetween without relying on scheduling or control information from a base station. In other examples, two or more UEs (e.g., UEs 226 and 228) within the coverage area of a base station (e.g., base station 212) may also communicate sidelink signals 227 over a direct link (sidelink) without conveying that communication through the base station 212. In this example, the base station 212 may allocate resources to the UEs 226 and 228 for the sidelink communication.

In order for transmissions over the air interface to obtain a low block error rate (BLER) while still achieving very high data rates, channel coding may be used. That is, wireless communication may generally utilize a suitable error correcting block code. In a typical block code, an information message or sequence is split up into code blocks (CBs), and an encoder (e.g., a CODEC) at the transmitting device then mathematically adds redundancy to the information message. Exploitation of this redundancy in the encoded information message can improve the reliability of the message, enabling correction for any bit errors that may occur due to the noise.

Data coding may be implemented in multiple manners. In early 5G NR specifications, user data is coded using quasi-cyclic low-density parity check (LDPC) with two different base graphs: one base graph is used for large code blocks and/or high code rates, while the other base graph is used otherwise. Control information and the physical broadcast channel (PBCH) are coded using Polar coding, based on nested sequences. For these channels, puncturing, shortening, and repetition are used for rate matching.

Aspects of the present disclosure may be implemented utilizing any suitable channel code. Various implementations of base stations and UEs may include suitable hardware and capabilities (e.g., an encoder, a decoder, and/or a CODEC) to utilize one or more of these channel codes for wireless communication.

In the RAN 200, the ability of UEs to communicate while moving, independent of their location, is referred to as mobility. The various physical channels between the UE and the RAN 200 are generally set up, maintained, and released under the control of an access and mobility management function (AMF). In some scenarios, the AMF may include a security context management function (SCMF) and a security anchor function (SEAF) that performs authentication. The SCMF can manage, in whole or in part, the security context for both the control plane and the user plane functionality.

In various aspects of the disclosure, the RAN 200 may utilize DL-based mobility or UL-based mobility to enable mobility and handovers (i.e., the transfer of a UE's connection from one radio channel to another). In a network configured for DL-based mobility, during a call with a scheduling entity, or at any other time, a UE may monitor various parameters of the signal from its serving cell as well as various parameters of neighboring cells. Depending on the quality of these parameters, the UE may maintain communication with one or more of the neighboring cells. During this time, if the UE moves from one cell to another, or if signal quality from a neighboring cell exceeds that from the serving cell for a given amount of time, the UE may undertake a handoff or handover from the serving cell to the neighboring (target) cell. For example, the UE 224 may move from the geographic area corresponding to its serving cell 202 to the geographic area corresponding to a neighbor cell 206. When the signal strength or quality from the neighbor cell 206 exceeds that of its serving cell 202 for a given amount of time, the UE 224 may transmit a reporting message to its serving base station 210 indicating this condition. In response, the UE 224 may receive a handover command, and the UE may undergo a handover to the cell 206.

In a network configured for UL-based mobility, UL reference signals from each UE may be utilized by the network to select a serving cell for each UE. In some examples, the base stations 210, 212, and 214/216 may broadcast unified synchronization signals (e.g., unified Primary Synchronization Signals (PSSs), unified Secondary Synchronization Signals (SSSs) and unified Physical Broadcast Channels (PBCHs)). The UEs 222, 224, 226, 228, 230, and 232 may receive the unified synchronization signals, derive the carrier frequency, and slot timing from the synchronization signals, and in response to deriving timing, transmit an uplink pilot or reference signal. The uplink pilot signal transmitted by a UE (e.g., UE 224) may be concurrently received by two or more cells (e.g., base stations 210 and 214/216) within the RAN 200. Each of the cells may measure a strength of the pilot signal, and the radio access network (e.g., one or more of the base stations 210 and 214/216 and/or a central node within the core network) may determine a serving cell for the UE 224. As the UE 224 moves through the RAN 200, the RAN 200 may continue to monitor the uplink pilot signal transmitted by the UE 224. When the signal strength or quality of the pilot signal measured by a neighboring cell exceeds that of the signal strength or quality measured by the serving cell, the RAN 200 may handover the UE 224 from the serving cell to the neighboring cell, with or without informing the UE 224.

Although the synchronization signal transmitted by the base stations 210, 212, and 214/216 may be unified, the synchronization signal may not identify a particular cell, but rather may identify a zone of multiple cells operating on the same frequency and/or with the same timing. The use of zones in 5G networks or other next generation communication networks enables the uplink-based mobility framework and improves the efficiency of both the UE and the network, since the number of mobility messages that need to be exchanged between the UE and the network may be reduced.

In various implementations, the air interface in the radio access network 200 may utilize licensed spectrum, unlicensed spectrum, or shared spectrum. Licensed spectrum provides for exclusive use of a portion of the spectrum, generally by virtue of a mobile network operator purchasing a license from a government regulatory body. Unlicensed spectrum provides for shared use of a portion of the spectrum without need for a government-granted license. While compliance with some technical rules is generally still required to access unlicensed spectrum, generally, any operator or device may gain access. Shared spectrum may fall between licensed and unlicensed spectrum, wherein technical rules or limitations may be required to access the spectrum, but the spectrum may still be shared by multiple operators and/or multiple RATs. For example, the holder of a license for a portion of licensed spectrum may provide licensed shared access (LSA) to share that spectrum with other parties, e.g., with suitable licensee-determined conditions to gain access.

The electromagnetic spectrum is often subdivided, based on frequency/wavelength, into various classes, bands, channels, etc. In 5G NR two initial operating bands have been identified as frequency range designations FR1 (410 MHZ-7.125 GHz) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into the mid-band frequencies. In addition, higher frequency bands are currently being explored to extend 5G NR operation beyond 52.6 GHz. For example, three higher operating bands have been identified as frequency range designations FR4-a or FR4-1 (52.6 GHz-71 GHZ), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

Devices communicating in the radio access network 200 may utilize one or more multiplexing techniques and multiple access algorithms to enable simultaneous communication of the various devices. For example, 5G NR specifications provide multiple access for UL transmissions from UEs 222 and 224 to base station 210, and for multiplexing for DL transmissions from base station 210 to one or more UEs 222 and 224, utilizing orthogonal frequency division multiplexing (OFDM) with a cyclic prefix (CP). In addition, for UL transmissions, 5G NR specifications provide support for discrete Fourier transform-spread-OFDM (DFT-s-OFDM) with a CP (also referred to as single-carrier FDMA (SC-FDMA)). However, within the scope of the present disclosure, multiplexing and multiple access are not limited to the above schemes, and may be provided utilizing time division multiple access (TDMA), code division multiple access (CDMA), frequency division multiple access (FDMA), sparse code multiple access (SCMA), resource spread multiple access (RSMA), or other suitable multiple access schemes. Further, multiplexing DL transmissions from the base station 210 to UEs 222 and 224 may be provided utilizing time division multiplexing (TDM), code division multiplexing (CDM), frequency division multiplexing (FDM), orthogonal frequency division multiplexing (OFDM), sparse code multiplexing (SCM), or other suitable multiplexing schemes.

Devices in the radio access network 200 may also utilize one or more duplexing algorithms. Duplex refers to a point-to-point communication link where both endpoints can communicate with one another in both directions. Full-duplex means both endpoints can simultaneously communicate with one another. Half-duplex means only one endpoint can send information to the other at a time. Half-duplex emulation is frequently implemented for wireless links utilizing time division duplex (TDD). In TDD, transmissions in different directions on a given channel are separated from one another using time division multiplexing. That is, in some scenarios, a channel is dedicated for transmissions in one direction, while at other times the channel is dedicated for transmissions in the other direction, where the direction may change very rapidly, e.g., several times per slot. In a wireless link, a full-duplex channel generally relies on physical isolation of a transmitter and receiver, and suitable interference cancellation technologies. Full-duplex emulation is frequently implemented for wireless links by utilizing frequency division duplex (FDD) or spatial division duplex (SDD). In FDD, transmissions in different directions may operate at different carrier frequencies (e.g., within paired spectrum). In SDD, transmissions in different directions on a given channel are separated from one another using spatial division multiplexing (SDM). In other examples, full-duplex communication may be implemented within unpaired spectrum (e.g., within a single carrier bandwidth), where transmissions in different directions occur within different sub-bands of the carrier bandwidth. This type of full-duplex communication may be referred to herein as sub-band full-duplex (SBFD), also known as flexible duplex.

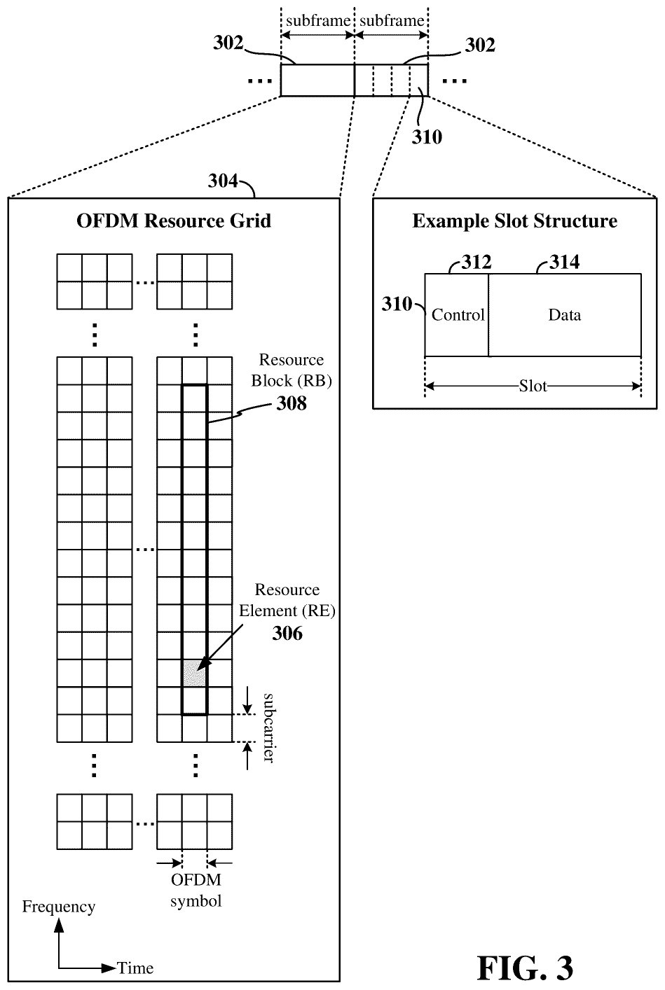

Various aspects of the present disclosure will be described with reference to an OFDM waveform, schematically illustrated in FIG. 3. It should be understood by those of ordinary skill in the art that the various aspects of the present disclosure may be applied to an SC-FDMA waveform in substantially the same way as described hereinbelow. That is, while some examples of the present disclosure may focus on an OFDM link for clarity, it should be understood that the same principles may be applied as well to SC-FDMA waveforms.

Referring now to FIG. 3, an expanded view of an exemplary subframe 302 is illustrated, showing an OFDM resource grid according to some aspects of the disclosure. However, as those skilled in the art will readily appreciate, the physical (PHY) transmission structure for any particular application may vary from the example described here, depending on any number of factors. Here, time is in the horizontal direction with units of OFDM symbols; and frequency is in the vertical direction with units of subcarriers of the carrier.

The resource grid 304 may be used to schematically represent time-frequency resources for a given antenna port. That is, in a multiple-input-multiple-output (MIMO) implementation with multiple antenna ports available, a corresponding multiple number of resource grids 304 may be available for communication. The resource grid 304 is divided into multiple resource elements (REs) 306. An RE, which is 1 subcarrier×1 symbol, is the smallest discrete part of the time-frequency grid, and contains a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 308, which contains any suitable number of consecutive subcarriers in the frequency domain. In one example, an RB may include 12 subcarriers, a number independent of the numerology used. In some examples, depending on the numerology, an RB may include any suitable number of consecutive OFDM symbols in the time domain. Within the present disclosure, it is assumed that a single RB such as the RB 308 entirely corresponds to a single direction of communication (either transmission or reception for a given device).

A set of continuous or discontinuous resource blocks may be referred to herein as a Resource Block Group (RBG), sub-band, or bandwidth part (BWP). A set of sub-bands or BWPs may span the entire bandwidth. Scheduling of scheduled entities (e.g., UEs) for downlink, uplink, or sidelink transmissions typically involves scheduling one or more resource elements 306 within one or more sub-bands or bandwidth parts (BWPs). Thus, a UE generally utilizes only a subset of the resource grid 304. In some examples, an RB may be the smallest unit of resources that can be allocated to a UE. Thus, the more RBs scheduled for a UE, and the higher the modulation scheme chosen for the air interface, the higher the data rate for the UE. The RBs may be scheduled by a scheduling entity, such as a base station (e.g., gNB, eNB, etc.), or may be self-scheduled by a UE implementing D2D sidelink communication.

In this illustration, the RB 308 is shown as occupying less than the entire bandwidth of the subframe 302, with some subcarriers illustrated above and below the RB 308. In a given implementation, the subframe 302 may have a bandwidth corresponding to any number of one or more RBs 308. Further, in this illustration, the RB 308 is shown as occupying less than the entire duration of the subframe 302, although this is merely one possible example.

Each 1 ms subframe 302 may consist of one or multiple adjacent slots. In the example shown in FIG. 3, one subframe 302 includes four slots 310, as an illustrative example. In some examples, a slot may be defined according to a specified number of OFDM symbols with a given cyclic prefix (CP) length. For example, a slot may include 7 or 14 OFDM symbols with a nominal CP. Additional examples may include mini-slots, sometimes referred to as shortened transmission time intervals (TTIs), having a shorter duration (e.g., one to three OFDM symbols). These mini-slots or shortened transmission time intervals (TTIs) may in some cases be transmitted occupying resources scheduled for ongoing slot transmissions for the same or for different UEs. Any number of resource blocks may be utilized within a subframe or slot.

An expanded view of one of the slots 310 illustrates the slot 310 including a control region 312 and a data region 314. In general, the control region 312 may carry control channels, and the data region 314 may carry data channels. Of course, a slot may contain all DL, all UL, or at least one DL portion and at least one UL portion. The structure illustrated in FIG. 3 is merely exemplary in nature, and different slot structures may be utilized, and may include one or more of each of the control region(s) and data region(s).

Although not illustrated in FIG. 3, the various REs 306 within a RB 308 may be scheduled to carry one or more physical channels, including control channels, shared channels, data channels, etc. Other REs 306 within the RB 308 may also carry pilots or reference signals. These pilots or reference signals may provide for a receiving device to perform channel estimation of the corresponding channel, which may enable coherent demodulation/detection of the control and/or data channels within the RB 308.

In some examples, the slot 310 may be utilized for broadcast, multicast, groupcast, or unicast communication. For example, a broadcast, multicast, or groupcast communication may refer to a point-to-multipoint transmission by one device (e.g., a base station, UE, or other similar device) to other devices. Here, a broadcast communication is delivered to all devices, whereas a multicast or groupcast communication is delivered to multiple intended recipient devices. A unicast communication may refer to a point-to-point transmission by one device to a single other device.

In an example of cellular communication over a cellular carrier via a Uu interface, for a DL transmission, the scheduling entity (e.g., a base station) may allocate one or more REs 306 (e.g., within the control region 312) to carry DL control information including one or more DL control channels, such as a physical downlink control channel (PDCCH), to one or more scheduled entities (e.g., UEs). The PDCCH carries downlink control information (DCI) including but not limited to power control commands (e.g., one or more open loop power control parameters and/or one or more closed loop power control parameters), scheduling information, a grant, and/or an assignment of REs for DL and UL transmissions. The PDCCH may further carry hybrid automatic repeat request (HARQ) feedback transmissions such as an acknowledgment (ACK) or negative acknowledgment (NACK). HARQ is a technique well-known to those of ordinary skill in the art, wherein the integrity of packet transmissions may be checked at the receiving side for accuracy, e.g., utilizing any suitable integrity checking mechanism, such as a checksum or a cyclic redundancy check (CRC). If the integrity of the transmission is confirmed, an ACK may be transmitted, whereas if not confirmed, a NACK may be transmitted. In response to a NACK, the transmitting device may send a HARQ retransmission, which may implement chase combining, incremental redundancy, etc.

The base station may further allocate one or more REs 306 (e.g., in the control region 312 or the data region 314) to carry other DL signals, such as a demodulation reference signal (DMRS); a phase-tracking reference signal (PT-RS); a channel state information (CSI) reference signal (CSI-RS); and a synchronization signal block (SSB). SSBs may be broadcast at regular intervals based on a periodicity (e.g., 5, 10, 20, 40, 80, or 160 ms). An SSB includes a primary synchronization signal (PSS), a secondary synchronization signal (SSS), and a physical broadcast control channel (PBCH). A UE may utilize the PSS and SSS to achieve radio frame, subframe, slot, and symbol synchronization in the time domain, identify the center of the channel (system) bandwidth in the frequency domain, and identify the physical cell identity (PCI) of the cell.

The PBCH in the SSB may further include a master information block (MIB) that includes various system information, along with parameters for decoding a system information block (SIB). The SIB may be, for example, a SystemInformationType 1 (SIB1) that may include various additional system information. The MIB and SIB1 together provide the minimum system information (SI) for initial access. Examples of system information transmitted in the MIB may include, but are not limited to, a subcarrier spacing (e.g., default downlink numerology), system frame number, a configuration of a PDCCH control resource set (CORESET) (e.g., PDCCH CORESET0), a cell barred indicator, a cell reselection indicator, a raster offset, and a search space for SIB1. Examples of remaining minimum system information (RMSI) transmitted in the SIB1 may include, but are not limited to, a random access search space, a paging search space, downlink configuration information, and uplink configuration information. A base station may transmit other system information (OSI) as well.

In an UL transmission, the scheduled entity (e.g., UE) may utilize one or more REs 306 to carry UL control information (UCI) including one or more UL control channels, such as a physical uplink control channel (PUCCH), to the scheduling entity. UCI may include a variety of packet types and categories, including pilots, reference signals, and information configured to enable or assist in decoding uplink data transmissions. Examples of uplink reference signals may include a sounding reference signal (SRS) and an uplink DMRS. In some examples, the UCI may include a scheduling request (SR), i.e., request for the scheduling entity to schedule uplink transmissions. Here, in response to the SR transmitted on the UCI, the scheduling entity may transmit downlink control information (DCI) that may schedule resources for uplink packet transmissions. UCI may also include HARQ feedback, channel state feedback (CSF), such as a CSI report, or any other suitable UCI.

In addition to control information, one or more REs 306 (e.g., within the data region 314) may be allocated for data. Such data may be carried on one or more traffic channels, such as, for a DL transmission, a physical downlink shared channel (PDSCH); or for an UL transmission, a physical uplink shared channel (PUSCH). In some examples, one or more REs 306 within the data region 314 may be configured to carry other signals, such as one or more SIBs and DMRSs. In some examples, the PDSCH may carry a plurality of SIBs, not limited to SIB1, discussed above. For example, the OSI may be provided in these SIBs, e.g., SIB2 and above.

In an example of sidelink communication over a sidelink carrier via a proximity service (ProSe) PC5 interface, the control region 312 of the slot 310 may include a physical sidelink control channel (PSCCH) including sidelink control information (SCI) transmitted by an initiating (transmitting) sidelink device (e.g., Tx V2X device or other Tx UE) towards a set of one or more other receiving sidelink devices (e.g., Rx V2X device or other Rx UE). The data region 314 of the slot 310 may include a physical sidelink shared channel (PSSCH) including sidelink data transmitted by the initiating (transmitting) sidelink device within resources reserved over the sidelink carrier by the transmitting sidelink device via the SCI. Other information may further be transmitted over various REs 306 within slot 310. For example, HARQ feedback information may be transmitted in a physical sidelink feedback channel (PSFCH) within the slot 310 from the receiving sidelink device to the transmitting sidelink device. In addition, one or more reference signals, such as a sidelink SSB, a sidelink CSI-RS, a sidelink SRS, and/or a sidelink positioning reference signal (PRS) may be transmitted within the slot 310.

These physical channels described above are generally multiplexed and mapped to transport channels for handling at the medium access control (MAC) layer. Transport channels carry blocks of information called transport blocks (TB). The transport block size (TBS), which may correspond to a number of bits of information, may be a controlled parameter, based on the modulation and coding scheme (MCS) and the number of RBs in a given transmission.

The channels or carriers illustrated in FIGS. 1, 2, and 3 are not necessarily all of the channels or carriers that may be utilized between devices, and those of ordinary skill in the art will recognize that other channels or carriers may be utilized in addition to those illustrated, such as other traffic, control, and feedback channels.

User equipment uplink transmissions may be synchronized with downlink transmissions to ensure that a start of an uplink frame from a plurality of user equipment is received at a base station at a same time. To compensate for the varying distances between the base station and individual ones of the plurality of user equipment, timing advance commands are sent from the base station to the UEs. A UE may utilize timing advance groups (TAGs) and associated time alignment timers to set the start of uplink frames and then monitor the degree of synchronization of the uplink frames with downlink frames. In an environment where one UE may be operationally coupled with multiple transmission and reception points (TRPs), the UE may need to handle multiple timing advance commands and monitor multiple time alignment timers. Timer handling for multi-timing advance operation for multi-transmit and receive points may become complex, because one UE is handling different timing advances for each of the multiple TRPs. Adding to the complexity are the identities and roles of various cells, such as the special cell (SpCell) the primary cell (PCell), the secondary cell (SCell) and the primary secondary cell (PSCell), as well as groupings of cells into master and secondary cell groups, primary-timing advance groups (P-TAGs) and secondary-timing advance groups (S-TAGs). Described herein are processes and circuitry relating to actions performed by a UE to manage the complexities of timing advance in a multi-TRP environment.

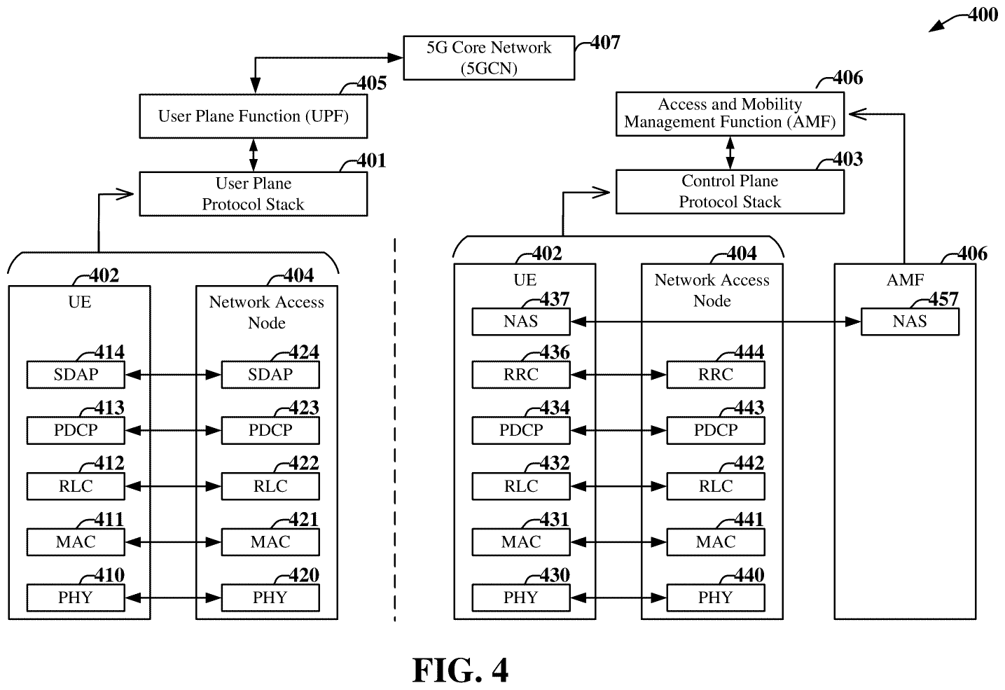

FIG. 4 is a block diagram illustrating protocol stacks 400 that may be implemented in a user plane and a control plane of various wireless communication devices (e.g., UEs and base stations), such as the various wireless communication devices shown and described above in connection with the examples of FIGS. 1 and/or 2. The protocol stacks 400 are illustrated as being implemented in a user equipment (UE) 402 (e.g., a client device), a network access node 404 (e.g., a gNB, a base station), and an access and mobility management function (AMF) 406. The user plane protocol stack 401 implemented at the UE 402 may include a Physical (PHY) 410 layer, a Medium Access Control (MAC) 411 layer, a Radio Link Control (RLC) 412 layer, a Packet Data Convergence Protocol (PDCP) 413 layer, and a Service Data Adaptation Protocol (SDAP) 414 layer. The user plane protocol stack 401 implemented at the network access node 404 corresponds to the protocol stack implemented at the UE 402. Accordingly, the user plane protocol stack 401 implemented at the network access node 404 may include a Physical (PHY) 420 layer, a Medium Access Control (MAC) 421 layer, a Radio Link Control (RLC) 422 layer, a Packet Data Convergence Protocol (PDCP) 423 layer, and a Service Data Adaptation Protocol (SDAP) 424 layer. In accordance with an open systems interconnection (OSI) model, the PHY layers 410, 420 may be referred to as a first layer or an L1 layer. The MAC 411, 421, RLC 412, 422, PDCP 413, 423, and SDAP 414, 424 layers may be referred to as a second layer or an L2 layer. User data (e.g., similar to downlink traffic 112 and uplink traffic 116 of FIG. 1) in each of the identified layers may be conveyed over an air interface (not shown) between the PHY 410 layer of the UE 402 and the PHY 420 layer of the network access node 404.

The control plane protocol stack 403 implemented at the UE 402 may include a PHY 430 layer, a MAC 431 layer, an RLC 432 layer, a PDCP 433 layer, a Radio Resource Control (RRC) 436 layer, and a non-access stratum (NAS) 437 layer. The control plane protocol stack 403 implemented at the network access node 404 corresponds to the protocol stack implemented at the UE 402 except for a NAS 437 layer. The NAS 437 layer passes through the network access node 404 but does not terminate at the network access node 404. Instead, the NAS 437 layer at the UE 402 terminates at a corresponding NAS 257 layer of the AMF 406. Based on the network access node 404 correspondence to the protocol stack implemented at the UE 402, the control plane protocol stack 403 implemented at the network access node 404 may include a PHY 440 layer, a MAC 441 layer, an RLC 442 layer, a PDCP 443 layer, and an RRC 444 layer. Control signaling messaging (e.g., similar to downlink control 114 and uplink control 118 of FIG. 1) in each of the identified layers may be conveyed over the air interface (not shown) between the PHY 430 layer of the UE 402 and the PHY 440 layer of the network access node 404.

A user plane function (UPF) 405 interfaces with the entities of the user plane protocol stack 401 and may be at least one of a function or circuit that at least one of functionally or operationally couples the user data conveyed over the user plane to a 5G core network (5GCN) 207. The UPF 405 may provide an interconnect point between the mobile infrastructure (e.g., network access nodes, TRPs, etc.) and a data network (not shown) such as the Internet. The AMF 406 may serve as the interface between the NAS 437, 457 entities in the control plane protocol stack 403. The AMF 406 may support, for example, the termination of NAS signaling, NAS ciphering & integrity protection, registration management, connection management, mobility management, access authentication and authorization, and security context management. Detailed explanations of just-identified user plane and control plane entities are available to those of skill in the art and will not be described herein for conciseness.

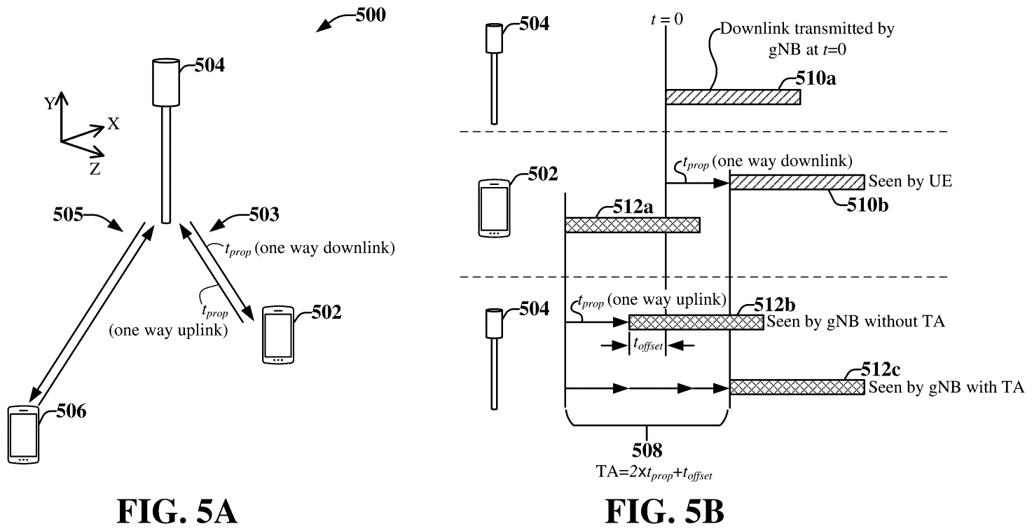

FIGS. 5A and 5B are schematic diagrams illustrating aspects of timing advance according to some aspects of the disclosure. FIG. 5A depicts a first UE 502 (e.g., a wireless communication device) and a second UE 506 at different distances from a base station 504 (e.g., a gNB, a network access node). The first UE 502 is closer to the base station than the second UE 506 in the X-Z plane of FIG. 5A.

FIG. 5B depicts the base station 504 and the first UE 502 at several instances in time and graphically represents downlink and uplink frames at those several instances in time. FIG. 5B illustrates timing advance in the context of propagation delay and timing offset from the perspectives of the base station 504 and the first UE 502.

Timing Advance (TA) may be executed by use of a command (i.e., a Timing Advance Command (TAC)) sent by a base station to a UE. The TAC causes the UE to adjust a timing of its uplink transmission. In practice, the implementation of TA may cause the UE to send uplink symbols in advance of a time that the UE would transmit the uplink symbols without TA. The uplink transmissions may be, for example, at least one of PUSCH, PUCCH, and SRS transmissions. The TAC informs the UE of the amount of time that the UE needs to advance the UE's uplink transmissions.

The TAC has at least two variants. The first variant may be referred to as an initial TAC. The initial TAC may be sent via a random access response (RAR) message, transmitted from the base station 504 to a UE (e.g., first UE 502 or second UE 506). The RAR may be a response to a random access preamble transmitted from the UE to the base station.

The second variant may convey a TAC via a medium access control-control element (MAC-CE). According to some aspects, timing advance may be controlled by a MAC entity (e.g., controlled at the MAC layer) and may be implemented by the physical layer.

The timing advance value may depend on the signal propagation delay between the base station (or a TRP) and the UE. Accordingly, different UEs located at various locations will have different timing advance values. The goal of the TAC is to align the uplink transmission from all UEs to a gNB (or a TRP).

Turning now to FIG. 5B, according to some aspects, an uplink frame 512a, having a given frame number (not shown), used for uplink transmission from the first UE 502, may start a given amount of time (i.e., TA microseconds) before a beginning of a corresponding downlink frame 510b as received at the first UE 502. The given amount of time may be referred to as the timing advance (TA). By starting the uplink frame 512a by TA microseconds before the beginning of the reception of the downlink frame 510b at the first UE 502, the starting edges of the downlink frame 510b (as seen at the first UE 502) and the uplink frame 512c (as seen by the base station 504) may be caused to coincide, or substantially coincide.

In the example of FIG. 5A, the first UE 502 is closer in distance to the base station 504 than a second UE 506. Accordingly, uplink and downlink transmissions of the first UE 502 (represented by the directions of a first set of arrows 503) will have a shorter (e.g., less elapsed time) propagation delay (tₚᵣₒₚ) than the uplink and downlink transmissions of the second UE 506 (represented by the directions of a second set of arrows 505). The physical distances, and therefore the temporal propagation delays, between the base station 504 and the first UE 502 and between the base station and the second UE 506 are represented by the lengths of the first set of arrows 503 and the lengths of the second set of arrows 505, respectively. Accordingly, when making timing adjustments, the first UE 502 may utilize a smaller (e.g., shorter) timing advance than the second UE 506.

As shown by the representative equation for TA 508 (i.e., TA=2×tₚᵣₒₚ+t_{offset}), TA 508 accounts for the round-trip propagation delay (i.e., 2×tₚᵣₒₚ) between a given UE 502, 506 and the base station 504. In addition, TA 508 also includes a timing offset (i.e., t_{offset}). The timing offset accounts for a difference between the start of the downlink frame 510a (e.g., at t=0) and the reception of the earlier start of the uplink frame 512b as seen by a gNB without the use of a timing advance on the uplink frame 512b.

A reference point for the first UE 502 initial transmit timing control value may be the downlink timing of a reference cell minus TA. The downlink timing of the reference cell may be defined as the time when a first detected path (in time) of a downlink frame 510b corresponding to an uplink frame 512a is received from the reference cell.

As seen from the side of the base station 504, the time difference between an uplink frame 512b and a corresponding downlink frame 510a is t_{offset}. The value of t_{offset} may be the same for all UEs attached to a base station (e.g., base station 504). Accordingly, the t_{offset} used by the second UE 506 and the first UE 502 may be the same.

A timing advance command may be given to a UE, such as at least one of the first UE 502 or the second UE 506 utilizing a medium access control-control element (MAC CE). Therefore, timing advance may be implanted by a MAC entity of a UE, such as, for example, the MAC 411 entity of the UE 402 of FIG. 4. Timing advance processes may utilize timing alignment timers such as those described herein. Heretofore, timing advance has been considered on a basis of one UE communicating with one base station in a given cell. However, according to some aspects, a UE may communicate with multiple transmission and reception points (multi-TRPs). According to these aspects, at least two timing advances corresponding to at least two respective TRPs (e.g., multi-TRPs) may be employed to account for the differences in distance (and therefore the difference in propagation delay) between a given UE and a first TRP and a second TRP.

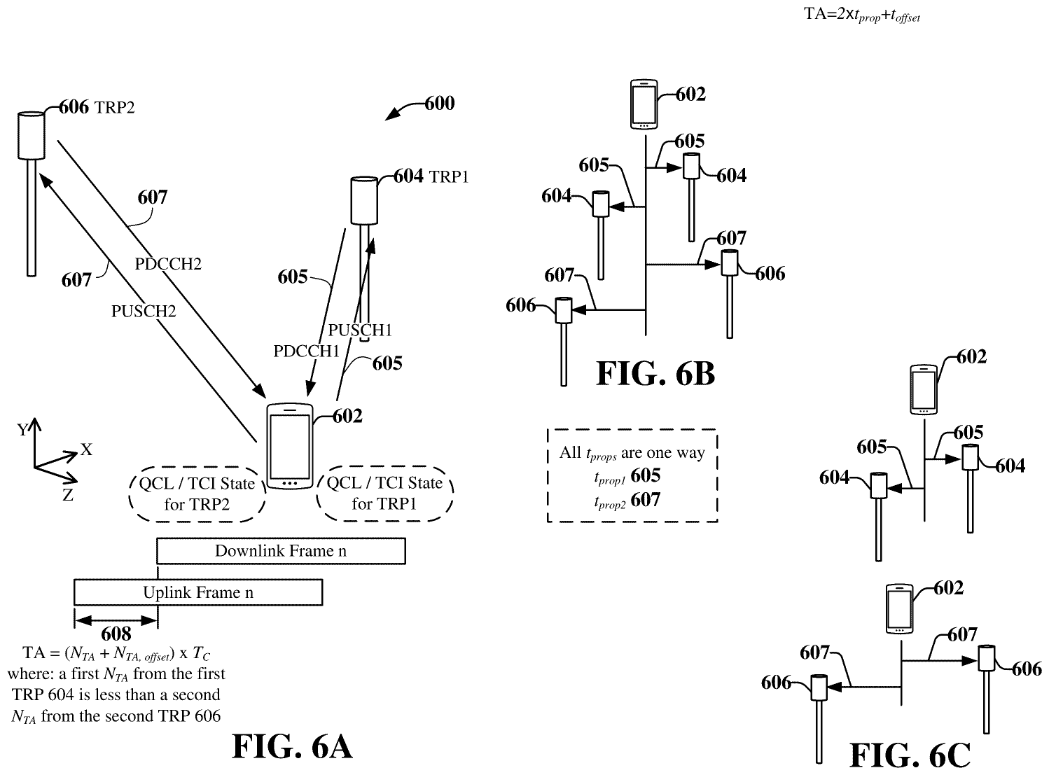

FIGS. 6A, 6B, and 6C are three versions, or perspectives, of a wireless communication network 600 in which a UE 602 is in a multi-transmission and reception point (multi-TRP) configuration with a first TRP 604 (TRP1) and a second TRP 606 (TRP2) according to some aspects of the disclosure.

In the example of FIG. 6A, the UE 602 is closer in distance to the first TRP 604 than it is to the second TRP 606. Accordingly, uplink and downlink transmissions between the UE 602 and the first TRP 604 (represented by the directions of the arrows therebetween) will have a shorter (e.g., less elapsed time) first propagation delay (tₚᵣₒₚ₁ 605) than the second propagation delay (tₚᵣₒₚ₂ 607) between the UE 602 and the second TRP 606. The physical distances, and therefore the temporal propagation delays, between the UE 602 and the first TRP 604 and between the UE 602 and the second TRP 606 are represented by the respective lengths of the arrows therebetween. Accordingly, when making timing adjustments, the UE 602 may utilize a smaller (e.g., shorter) timing advance for uplink transmissions to the first TRP 604 than it uses for uplink transmissions to the second TRP 606.

The equation for TA 508 (i.e., TA=2×tₚᵣₒₚ+t_{offset}) as shown and described in connection with FIG. 5 is also applicable to the timing advances that may be used in connection with the wireless communication network 600 of FIG. 6. Alternatively, as shown in FIG. 6A, a different equation for TA 608 may be used to account for the round-trip propagation delay (i.e., 2×tₚᵣₒₚ) plus some offset between the UE 602 and the respective first TRP 604 and second TRP 606.

The different equation for TA 608 may be expressed as follows: TA=(N_{TA}+N_{TA, offset})×T_{C}, where: N_{TA} is a measured value sent to the UE 602 from the first TRP 604 as part of a Timing Advance Command (TAC). Due to the difference in distances from the first TRP 604 to the UE 602 and from the second TRP 606 to the UE 602, the value of N_{TA} sent from the second TRP 606 to the UE 602 will be different from the value of N_{TA} sent from the first TRP 604 to the UE 602. N_{TA, offset} represents fixed values that vary according to different frequency bands and subcarrier spacing. T_{C} is known as a basic time unit 5G NR systems and is equal to 0.509 ns.

The initial TAC via RAR may set a first TA. When the TA of the UE needs to be corrected, a given base station (e.g., first TRP 604 and/or second TRP 606) will send a TAC to the UE 603, commanding the UE 602 to adjust the uplink transmission timing. The TAC may be sent to the UE 602 via a TAC MAC CE. The TAC MAC CE may have a fixed 8 bits, of which the first two bits represent a TAG identity (TAG ID), and the final 6 bits represent the TAC. The TAG ID indicates the Timing Advance Group Identity. The TAG containing a SpCell has the TAG Identity of 0. The TAC field indicates the index value TA (0, 1, 2, . . . 63) used to control the amount of timing adjustment that the MAC entity (e.g., similar to the MAC entity 431 as shown and described in connection with FIG. 4) is commanded to apply. The UE 602 may determine the degree of uplink synchronization at the MAC layer based on a timer referred to herein as a timeAlignmentTimer. The time AlignmentTimer is provided to the UE via RRC signaling (e.g., via an RRC entity, similar to the RRC entity 436 as shown and described in connection with FIG. 4).

FIG. 6B illustrates the multi-TRP wireless communication network 600 in a second perspective, in which single downlink timing is used according to some aspects described herein. When single downlink timing is applied, the multiple TRPs may be synchronized in a single downlink timing to transmit signals in downlink to the UE 602. FIG. 6C illustrates the multi-TRP wireless communication network 600 in a third perspective, in which separate downlink timing is used according to some aspects described herein. When separate downlink timings are applied, the multiple TRPs may apply separate downlink timings to transmit signals in downlink to the UE 602.

According to another example, when a maximum TA difference is exceeded between TAGs of the same cell, at least one of the following occurrences may be undertaken by a MAC entity or, more broadly, by a UE:
an uplink transmission may be stopped on one of the TAGs of the same cell, or
the timeAlignmentTimers corresponding to the TAGs of the same cell may all be considered as expired.

In one aspect, examples of the one TAG (having the stopped uplink transmission) include a TAG associated with a lower TRP ID, or a lower TAG ID, a larger TA value, or a TAG or TAGs associated with a lower control resource set pool index value (CORESETPoolIndex), a lower close loop index value, or a lower TCI group ID.

In greater detail, when the MAC entity, or more broadly the UE, stops uplink transmissions for at least one of an SCell or a TRP due to at least one of:
the maximum uplink transmission timing difference between TAGs (of the MAC entity, or more broadly, the UE) is exceeded, or
the maximum uplink transmission timing difference between TAGs (of any MAC entity of the UE) is exceeded,
   the MAC entity, or more broadly the UE, may consider the timeAlignmentTimer(s) associated with the at least one of the SCell or the TRP as being expired.

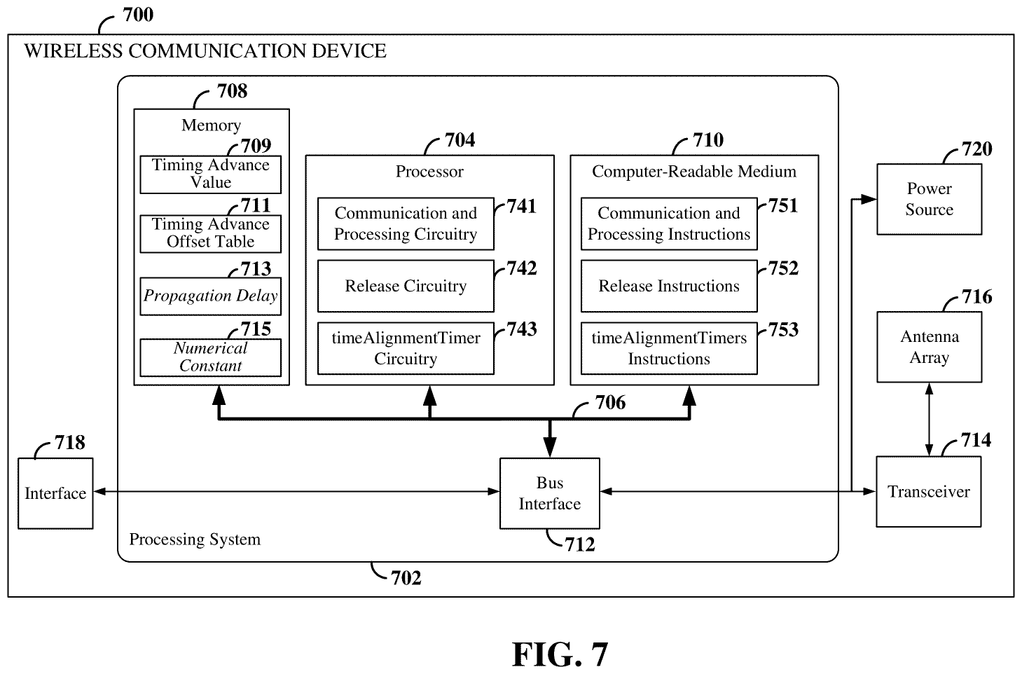

FIG. 7 is a block diagram illustrating an example of a hardware implementation of a wireless communication device 700 (e.g., a UE) employing a processing system 702 according to some aspects of the disclosure. The wireless communication device 700 may be a scheduled entity (e.g., a UE) or a scheduling entity (e.g., a base station, a gNB) as illustrated in any one or more of FIGS. 1, 2, 4, 5 and/or 6.

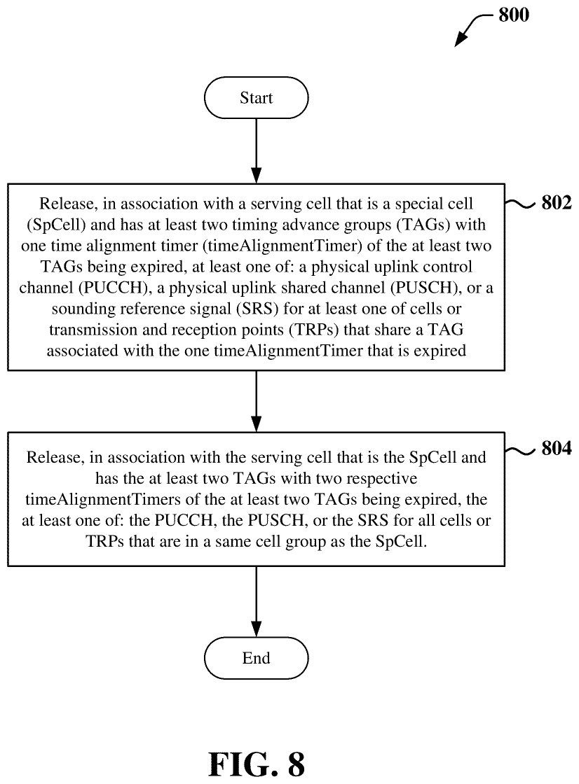

In accordance with various aspects of the disclosure, an element, or any portion of an element, or any combination of elements may be implemented with a processing system 702 that includes one or more processors, such as processor 704. Examples of processors 704 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the wireless communication device 700 may be configured to perform any one or more of the functions described herein. That is, the processor 704, as utilized in the wireless communication device 700, may be used to implement any one or more of the methods or processes described and illustrated, for example, in any one or more of FIGS. 8-14.

The processor 704 may in some examples be implemented via a baseband or modem chip and in other implementations, the processor 704 may include a number of devices distinct and different from a baseband or modem chip (e.g., in such scenarios as may work in concert to achieve examples discussed herein). And as mentioned above, various hardware arrangements and components outside of a baseband modem processor can be used in implementations, including RF-chains, power amplifiers, modulators, buffers, interleavers, adders/summers, etc.

In this example, the processing system 702 may be implemented with a bus architecture, represented generally by the bus 706. The bus 706 may include any number of interconnecting buses and bridges depending on the specific application of the processing system 702 and the overall design constraints. The bus 706 communicatively couples together various circuits, including one or more processors (represented generally by the processor 704), a memory 708, and computer-readable media (represented generally by the computer-readable medium 710). The bus 706 may also link various other circuits such as timing sources, peripherals, voltage regulators, and power management circuits, which are well known in the art, and therefore, will not be described any further.

A bus interface 712 provides an interface between the bus 706 and a transceiver 714. The transceiver 714 may be a wireless transceiver. The transceiver 714 may provide a means for communicating with various other apparatus over a transmission medium (e.g., air interface). The transceiver 714 may further be coupled to one or more antenna arrays (hereinafter antenna array 716). The bus interface 712 further provides an interface between the bus 706 and a user interface 718 (e.g., keypad, display, touch screen, speaker, microphone, control features, etc.). Of course, such a user interface 718 is optional and may be omitted in some examples. In addition, the bus interface 712 further provides an interface between the bus 706 and a power source 720 of the wireless communication device 700.

The processor 704 is responsible for managing the bus 706 and general processing, including the execution of software stored on the computer-readable medium 710. The software, when executed by the processor 704, causes the processing system 702 to perform the various functions described below for any particular apparatus. The computer-readable medium 710 and the memory 708 may also be used for storing data that is manipulated by the processor 704 when executing software. The data may include data in look-up table(s) 709, such as the look-up table(s) described above according to some aspects of the disclosure.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on the computer-readable medium 710. When executed by the processor 704, the software may cause the processing system 702 to perform the various processes and functions described herein for any particular apparatus.

The computer-readable medium 710 may be a non-transitory computer-readable medium and may be referred to as a computer-readable storage medium or a non-transitory computer-readable medium. The non-transitory computer-readable medium may store computer-executable code (e.g., processor-executable code). The computer-executable code may include code for causing a computer (e.g., a processor) to implement one or more of the functions described herein. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 710 may reside in the processing system 702, external to the processing system 702, or distributed across multiple entities including the processing system 702. The computer-readable medium 710 may be embodied in a computer program product or article of manufacture. By way of example, a computer program product or article of manufacture may include a computer-readable medium in packaging materials. In some examples, the computer-readable medium 710 may be part of the memory 708. Those skilled in the art will recognize how best to implement the described functionality presented throughout this disclosure depending on the particular application and the overall design constraints imposed on the overall system.

In some aspects of the disclosure, the processor 704 may include communication and processing circuitry 741 configured for various functions, including, for example, communicating with other wireless communication devices (e.g., a scheduling entity, a scheduled entity), a network core (e.g., a 5G core network), or any other entity, such as, for example, local infrastructure or an entity communicating with the wireless communication device 700 via the Internet, such as a network provider. In some examples, the communication and processing circuitry 741 may include one or more hardware components that provide the physical structure that performs processes related to wireless communication (e.g., signal reception and/or signal transmission) and signal processing (e.g., processing a received signal and/or processing a signal for transmission). For example, the communication and processing circuitry 741 may include one or more transmit/receive chains.

In some implementations where the communication involves receiving information, the communication and processing circuitry 741 may obtain or identify information from a component of the wireless communication device 700 (e.g., from the transceiver 714 that receives the information via radio frequency signaling or some other type of signaling suitable for the applicable communication medium), process (e.g., decode) the information, and output the processed information. For example, the communication and processing circuitry 741 may output the information to another component of the processor 704, to the memory 708, or to the bus interface 712. In some examples, the communication and processing circuitry 741 may receive one or more of: signals, messages, other information, or any combination thereof. In some examples, the communication and processing circuitry 741 may receive information via one or more channels. In some examples, the communication and processing circuitry 741 may include functionality for a means for receiving. In some examples, the communication and processing circuitry 741 may include functionality for a means for processing, including a means for demodulating, a means for decoding, etc.

In some implementations where the communication involves sending (e.g., transmitting) information, the communication and processing circuitry 741 may obtain or identify information (e.g., from another component of the processor 704, the memory 708, or the bus interface 712), process (e.g., modulate, encode, etc.) the information, and output the processed information. For example, the communication and processing circuitry 741 may obtain data stored in the memory 708 and may process the obtained data according to some aspects of the disclosure. For example, the communication and processing circuitry 741 may obtain a timing advance value (e.g., N_{TA}) (received, for example, via a MAC CE) from timing advance value 709 portion of the memory 708, or may obtain a propagation delay value (e.g., tₚᵣₒₚ) from the propagation delay portion of the memory 708. Still further, the communication and processing circuitry 741 may obtain a timing advance offset value (e.g., N_{TA, offset}) from a timing advance offset table 711 of the memory 708. Still further, the communication and processing circuitry 741 may obtain a value of a numerical constant, such as, for example T_{C}, from a numerical constant 715 portion of the memory 708. The communication and processing circuitry 741 may determine, from one or more combinations of two or more values and/or constants, a value of TA to be applied to an uplink transmission from the wireless communication device 700.

In some examples, the communication and processing circuitry 741 may obtain information and may output the information to the transceiver 714 (e.g., that transmits the information via radio frequency signaling or some other type of signaling suitable for the applicable communication medium). In some examples, the communication and processing circuitry 741 may send one or more of signals, messages, other information, or any combination thereof. In some examples, the communication and processing circuitry 741 may send information via one or more channels. In some examples, the communication and processing circuitry 741 may include functionality for a means for sending (e.g., a means for transmitting). In some examples, the communication and processing circuitry 741 may include functionality for a means for generating, including a means for modulating, a means for encoding, etc. In some examples, the communication and processing circuitry 741 may be configured to receive and process uplink traffic and uplink control messages (e.g., similar to uplink traffic 116 and uplink control 118 of FIG. 1) and process and transmit downlink traffic and downlink control messages (e.g., similar to downlink traffic 112 and downlink control 114 of FIG. 1) via the antenna array 716 and the transceiver 714.

The communication and processing circuitry 741 may further be configured to execute communication and processing instructions 751 (e.g., software) stored on the computer-readable medium 710 to implement one or more functions described herein.

In some aspects of the disclosure, the processor 704 may include release circuitry 742. The release circuitry may include hardware used to configure the release of, for example, at least one of a PUCCH, a PUSCH or an SRS. The release circuitry 742 of FIG. 7 may be configured for various functions, including, for example, causing a MAC entity, such as, for example, the MAC 431 entity as shown and described in connection with FIG. 4, or more generally a UE, such as, for example, the UE 402 as shown and described in connection with FIG. 4, to notify a radio resource control (RRC) entity, such as, for example, the RRC 436 entity as shown and described in connection with FIG. 4, to release a PUCCH for one or more serving cells, if configured, or to notify the RRC entity to release a PUSCH for one or more serving cells, if configured. or to notify the RRC entity to release an SRS for one or more serving cells, if configured. These one or two releases may individually or collectively be referred to herein as a MAC entity release.

According to another example, for a per-TRP MAC entity release, the release circuitry 742 may be configured to cause a MAC entity of the wireless communication device (or more generally, the wireless communication device 700 itself (e.g., the UE itself)) to identify (e.g., determine, obtain) HARQ identities (HARQ IDs) are associated with a TAG that has an expired timeAlignmentTimer. The HARQ buffers associated with the identified HARQ IDs may be flushed. For example, the MAC entity may identify HARQ IDs whose latest scheduling CORESETPoolIndex matches the scheduling CORESETPoolIndex of an expired TAG. Thereafter, the release circuitry 742 may cause the MAC entity to flush all HARQ buffers associated with the identified HARQ IDs.

According to another example, for a per-TRP MAC entity release, to determine at least one of a to-be-released or to-be-cleared at least one of a PUCCH, a PUSCH, a sounding reference signal (SRS), a semi-persistent scheduling (SPS), a configured grant (CG), or a physical uplink shared channel (PUSCH) with semi-persistent-channel state information (SP-CSI) associated with an expired timeAlignmentTimer. At least one of the above resources may share a unified transmission configuration indicator (TCI) assigned to a CORESETPoolIndex mapped to the TAG whose timeAlignmentTimer has expired.

In one example, a serving cell, which may be a SpCell, may have two timing advance groups (TAGs) and two respective timeAlignmentTimers. Either or both of the two TAGs may be defined as a P-TAG. In this case, the MAC entity release may, for example, have the following behavior.

For an SpCell with two TAGS:
if only one timeAlignmentTimer of the two respective timeAlignmentTimers expires, the MAC entity release may be performed only for at least one of cell(s) or TRP(s) sharing the same TAG (even if that TAG is a P-TAG); and
if both timeAlignmentTimers of the two respective timeAlignmentTimers expires, the MAC entity release may be performed for all of the at least one of cell(s) or/TRP(s) in the same cell group.

For other cases, a legacy-like behavior may be applied. Consider, for example and without limitation, the following two cases:
Case 1: if any timeAlignmentTimer has expired for any TAG on one or more SCells (e.g., if any timeAlignmentTimer has expired for an S-TAG other than on a SpCell), the MAC entity release may be performed for the at least one of cell(s) or TRP(s) sharing the same TAG(s); and
Case 2: if an SpCell only has a single TAG, whose timeAlignmentTimer expires, the MAC entity release may be performed for all of the at least one of cell(s) or TRP(s) in the same cell group.

According to still another example, for a SpCell with two TAGs, where only one of the two TAGs is configured as a P-TAG (e.g., the one TAG associated with a particular CORESETPoolIndex, or with a lower TAG ID, or as indicated by a network), in response to the expiration of the time AlignmentTimer of the P-TAG, the release circuitry 742 may be configured to perform a MAC entity release, which may be performed for at least one of all cell(s) or all TRP(s) in a same cell group.

The release circuitry 742 may further be configured to execute release instructions 752 (e.g., software) stored on the computer-readable medium 710 to implement one or more functions described herein.

In some aspects of the disclosure, the processor 704 may include timeAlignmentTimer circuitry 743. The timeAlignmentTimer circuitry 743 may be configured for various functions, including, for example, in an instance where a timeAlignmentTimer of an S-TAG expires, performing at least one of two possible courses of action. Namely, a first course of action may include performing a MAC entity release by any TRP in a single-TAG cell or any TRP in a two-TAG cell that uses the same S-TAG. A second course of action may include performing the MAC entity release by any cell, including the SpCell, that contains the same S-TAG. In addition, if the SpCell contains an S-TAG whose timeAlignmentTimer expires, a MAC entity release may be performed for all of the at least one of cell(s) or TRP(s) in the same cell group as the SpCell.

According to another example, for an SpCell with two TAGs, where both of the two TAGS are P-TAGs, if a timeAlignmentTimer of any of the P-TAGs expires, the MAC entity release may be performed for all of the at least one of cell(s) or TRP(s) in the same cell group of the SpCell.

Also, for an SpCell with two TAGs, where both of the two TAGS are P-TAGs, if a timeAlignmentTimer of an S-TAG expires, at least two possible courses of action may be performed. According to the first course of action, any single-TAG cell or any TRP in a cell configured with two TAGs (i.e., a two-TAG cell) that uses the same S-TAG may perform the MAC entity release. On a per-TRP basis, the UE or the MAC entity may identify the HARQ IDs of HARQ buffers that are to-be-flushed, and may flush, or may cause another entity to flush, the HARQ buffers associated with the identified HARQ IDs. According to the second course of action, any cell that includes the same S-TAG may perform the MAC entity release.

The timeAlignmentTimer circuitry 743 may further be configured to execute timeAlignmentTimer instructions 753 (e.g., software) stored on the computer-readable medium 710 to implement one or more functions described herein.

FIG. 8 is a flow chart illustrating an exemplary process 800 (e.g., a method of wireless communication) at a user equipment (UE) (e.g., at a wireless communication device, at a scheduled entity) according to some aspects of the disclosure. The process 800 may occur in a wireless communication network, such as the wireless communication networks of FIGS. 1 and/or 2, for example. As described below, some or all illustrated features may be omitted in a particular implementation within the scope of the present disclosure, and some illustrated features may not be required for all implementations. In some examples, the process 800 may be carried out by the wireless communication device 700 described and illustrated in connection with FIG. 7. In some examples, the process 800 may be carried out by any suitable apparatus or means for carrying out the functions or algorithms described herein.

At block 802, the UE may release, in association with a serving cell that is a special cell (SpCell) and has at least two timing advance groups (TAGs) with one time alignment timer (timeAlignmentTimer) of the at least two TAGs being expired, at least one of: a physical uplink control channel (PUCCH), a physical uplink shared channel (PUSCH), or a sounding reference signal (SRS) for at least one of cells or transmission and reception points (TRPs) that share a TAG associated with the one timeAlignmentTimer that is expired. For example, the release circuitry 742, shown and described above in connection with FIG. 7, may provide a means for releasing, in association with a serving cell that is a special cell (SpCell) and has at least two timing advance groups (TAGs) with one time alignment timer (timeAlignmentTimer) of the at least two TAGs being expired, at least one of: a physical uplink control channel (PUCCH), a physical uplink shared channel (PUSCH), or a sounding reference signal (SRS) for at least one of cells or transmission and reception points (TRPs) that share a TAG associated with the one timeAlignmentTimer that is expired.

At block 804, the UE may release, in association with the serving cell that is the SpCell and has the at least two TAGs with two respective timeAlignmentTimers of the at least two TAGs being expired, at least one of: the PUCCH, the PUSCH, or the SRS for all cells or TRPs that are in a same cell group as the SpCell. For example, the release circuitry 742, shown and described above in connection with FIG. 7, may provide a means for releasing, in association with the serving cell that is the SpCell and has the at least two TAGs with two respective timeAlignmentTimers of the at least two TAGs being expired, at least one of: the PUCCH, the PUSCH, or the SRS for all cells or TRPs that are in a same cell group as the SpCell.

According to some aspects, a medium access control (MAC) entity of the UE determines to release the at least one of: the PUCCH, the PUSCH, or the SRS and notifies a radio resource control (RRC) entity of the UE to perform the releasing of the at least one of: the PUCCH, the PUSCH, or the SRS.

According to some aspects, the SpCell may be at least one of:
a primary cell (PCell) of a master cell group (MCG),
a primary secondary cell (PSCell) of a secondary cell group (SCG), or
is otherwise a PCell.

According to some aspects the SpCell may support PUCCH transmission and contention-based random access.

According to some aspects, each of the at least two TAGs may be a respective group of serving cells that, for cells with an uplink configured, use a same timing reference cell and a same timing advance value.

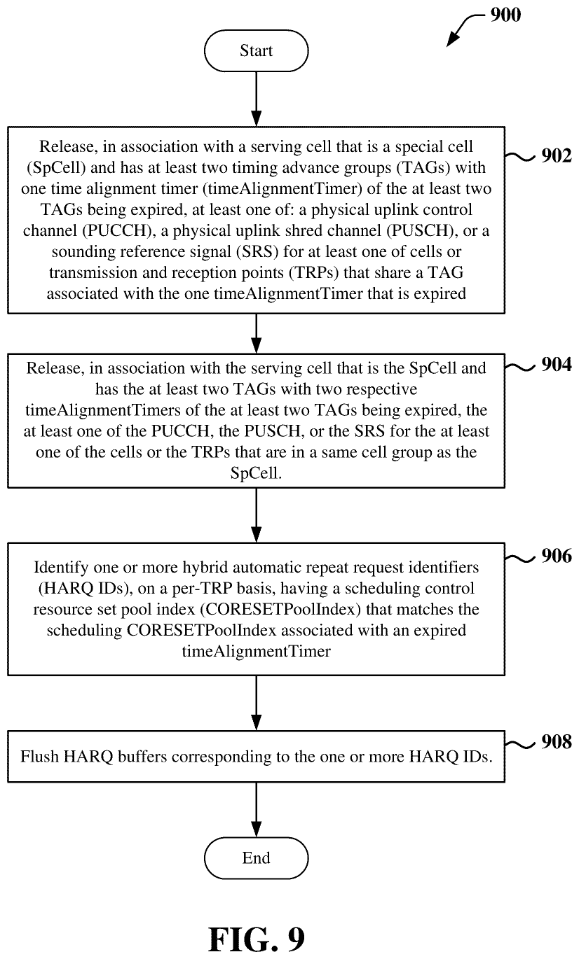

FIG. 9 is a flow chart illustrating an exemplary process 900 (e.g., a method of wireless communication) at a user equipment (UE) (e.g., at a wireless communication device, at a scheduled entity) according to some aspects of the disclosure. The process 900 may occur in a wireless communication network, such as the wireless communication networks of FIGS. 1 and/or 2, for example. As described below, some or all illustrated features may be omitted in a particular implementation within the scope of the present disclosure, and some illustrated features may not be required for all implementations. In some examples, the process 900 may be carried out by the wireless communication device 700 described and illustrated in connection with FIG. 7. In some examples, the process 900 may be carried out by any suitable apparatus or means for carrying out the functions or algorithms described herein.

At block 902, the UE may duplicate the process described at block 802 of FIG. 8. Namely, at block 902, the UE may release, in association with a serving cell that is a special cell (SpCell) and has at least two timing advance groups (TAGs) with one time alignment timer (timeAlignmentTimer) of the at least two TAGs being expired, at least one of a physical uplink control channel (PUCCH), a physical uplink shared channel (PUSCH), or a sounding reference signal (SRS) for at least one of cells or transmission and reception points (TRPs) that share a TAG associated with the one time AlignmentTimer that is expired. For example, the release circuitry 742, shown and described above in connection with FIG. 7, may provide a means for releasing, in association with a serving cell that is a special cell (SpCell) and has at least two timing advance groups (TAGs) with one time alignment timer (timeAlignmentTimer) of the at least two TAGs being expired, at least one of: a physical uplink control channel (PUCCH), a physical uplink shared channel (PUSCH), or a sounding reference signal (SRS) for at least one of cells or transmission and reception points (TRPs) that share a TAG associated with the one timeAlignmentTimer that is expired.

At block 904, the UE may duplicate the process described at block 804 of FIG. 8. Namely, at block 904, the UE may release, in association with the serving cell that is the SpCell and has the at least two TAGs with two respective timeAlignmentTimers of the at least two TAGs being expired, the at least one of: the PUCCH, the PUSCH, or the SRS for the at least one of cells or TRPs that are in a same cell group as the SpCell. For example, the release circuitry 742, shown and described above in connection with FIG. 7, may provide a means for releasing, in association with the serving cell that is the SpCell and has the at least two TAGs with two respective timeAlignmentTimers of the at least two TAGs being expired, the at least one of: the PUCCH, the PUSCH, or the SRS for the at least one of cells or TRPs that are in a same cell group as the SpCell.

At block 906, the UE may identify one or more hybrid automatic repeat request identifiers (HARQ IDs), on a per-TRP basis, having a scheduling control resource set pool index (CORESETPoolIndex) that matches the scheduling CORESETPoolIndex associated with an expired timeAlignmentTimer. For example, the communication and processing circuitry 741, shown and described above in connection with FIG. 7, may provide a means for identifying one or more hybrid automatic repeat request identifiers (HARQ IDs), on a per-TRP basis, having a scheduling control resource set pool index (CORESETPoolIndex) that matches the scheduling CORESETPoolIndex associated with an expired timeAlignmentTimer.

At block 908, the UE may flush HARQ buffers corresponding to the one or more HARQ IDs. For example, the communication and processing circuitry 741, shown and described above in connection with FIG. 7, may provide a means for flushing HARQ buffers corresponding to the one or more HARQ IDs.

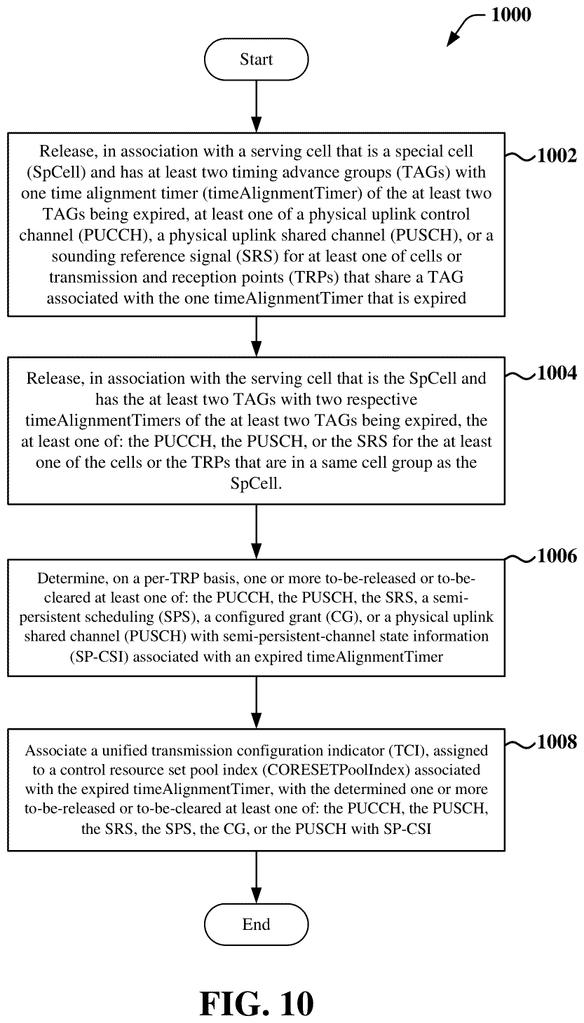

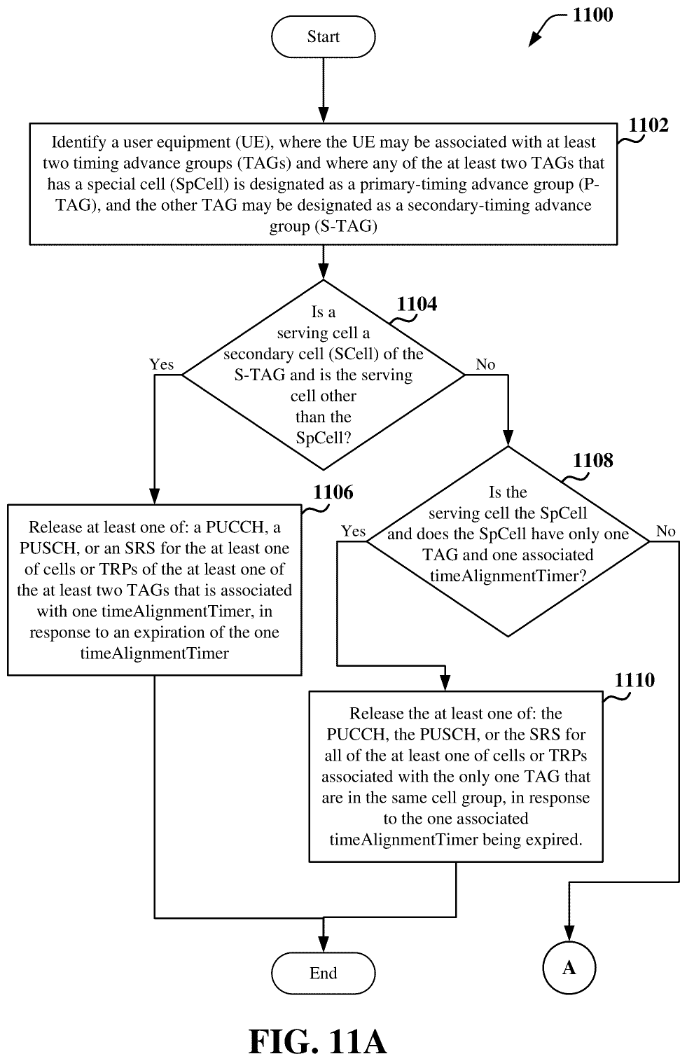

FIG. 10 is a flow chart illustrating an exemplary process 1000 (e.g., a method of wireless communication) at a user equipment (UE) (e.g., at a wireless communication device, at a scheduled entity) according to some aspects of the disclosure. The process 1000 may occur in a wireless communication network, such as the wireless communication networks of FIGS. 1 and/or 2, for example. As described below, some or all illustrated features may be omitted in a particular implementation within the scope of the present disclosure, and some illustrated features may not be required for all implementations. In some examples, the process 1000 may be carried out by the wireless communication device 700 described and illustrated in connection with FIG. 7. In some examples, the process 1000 may be carried out by any suitable apparatus or means for carrying out the functions or algorithms described herein.

At block 1002, the UE may duplicate the process described at blocks 802 of FIG. 8 and 902 of FIG. 9. Namely, at block 1002, the UE may release, in association with a serving cell that is a special cell (SpCell) and has at least two timing advance groups (TAGs) with one time alignment timer (timeAlignmentTimer) of the at least two TAGs being expired, at least one of: a physical uplink control channel (PUCCH), a physical uplink shared channel (PUSCH), or a sounding reference signal (SRS) for at least one of cells or transmission and reception points (TRPs) that share a TAG associated with the one timeAlignmentTimer that is expired. For example, the release circuitry 742, shown and described above in connection with FIG. 7, may provide a means for releasing, in association with a serving cell that is a special cell (SpCell) and has at least two timing advance groups (TAGs) with one time alignment timer (timeAlignmentTimer) of the at least two TAGs being expired, at least one of: a physical uplink control channel (PUCCH), a physical uplink shared channel (PUSCH), or a sounding reference signal (SRS) for at least one of cells or transmission and reception points (TRPs) that share a TAG associated with the one timeAlignmentTimer that is expired.

At block 1004, the UE may duplicate the process described at blocks 804 of FIG. 8 and 904 of FIG. 9. Namely, at block 1004, the UE may release, in association with the serving cell that is the SpCell and has the at least two TAGs with two respective timeAlignmentTimers of the at least two TAGs being expired, the at least one of: the PUCCH, the PUSCH, or the SRS for the at least one of cells or TRPs that are in a same cell group as the SpCell. For example, the release circuitry 742, shown and described above in connection with FIG. 7, may provide a means for releasing, in association with the serving cell that is the SpCell and has the at least two TAGs with two respective timeAlignmentTimers of the at least two TAGs being expired, the at least one of: the PUCCH, the PUSCH, or the SRS for the at least one of cells or TRPs that are in a same cell group as the SpCell.

At block 1006, the UE may determine, on a per-TRP basis, one or more to-be-released or to-be-cleared at least one of: the PUCCH, the PUSCH, the SRS, a semi-persistent scheduling (SPS), a configured grant (CG), or a physical uplink shared channel (PUSCH) with semi-persistent-channel state information (SP-CSI) associated with an expired timeAlignmentTimer. For example, the release circuitry 742, shown and described above in connection with FIG. 7, may provide a means for determining, on a per-TRP basis, one or more to-be-released or to-be-cleared at least one of: the PUCCH, the PUSCH, the SRS, a semi-persistent scheduling (SPS), a configured grant (CG), or a physical uplink shared channel (PUSCH) with semi-persistent-channel state information (SP-CSI) associated with an expired timeAlignmentTimer.

At block 1008, the UE may associate a unified transmission configuration indicator (TCI), assigned to a control resource set pool index (CORESETPoolIndex) associated with the expired timeAlignmentTimer, with the determined one or more to-be-released or to-be-cleared at least one of: the PUCCH, the PUSCH, the SRS, the SPS, the CG, or the PUSCH with SP-CSI. For example, the communications and processing circuitry 741, shown and described above in connection with FIG. 7, may provide a means for associating a unified transmission configuration indicator (TCI), assigned to a control resource set pool index (CORESETPoolIndex) associated with the expired timeAlignmentTimer, with the determined one or more to-be-released or to-be-cleared at least one of: the PUCCH, the PUSCH, the SRS, the SPS, the CG, or the PUSCH with SP-CSI.

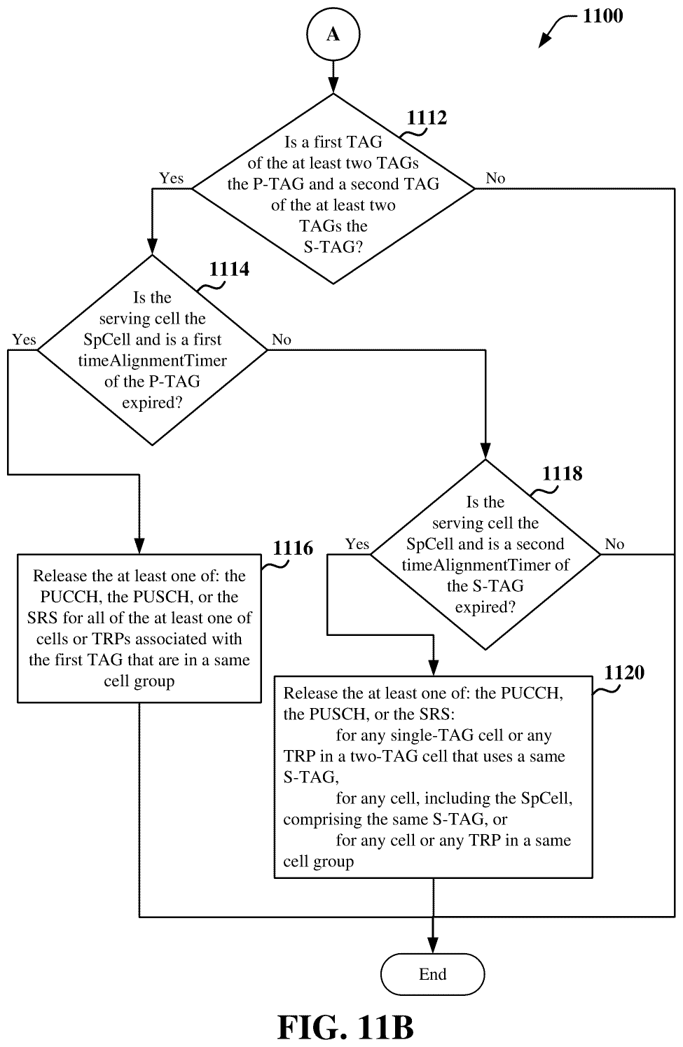

FIG. 11 is a flow chart illustrating an exemplary process 1100 (e.g., a method of wireless communication) at a user equipment (UE) (e.g., at a wireless communication device, at a scheduled entity) according to some aspects of the disclosure. FIG. 11 is comprised of two sheets of drawings identified as FIG. 11A and FIG. 11B. The process 1100 may occur in a wireless communication network, such as the wireless communication networks of FIGS. 1 and/or 2, for example. As described below, some or all illustrated features may be omitted in a particular implementation within the scope of the present disclosure, and some illustrated features may not be required for all implementations. In some examples, the process 1100 may be carried out by the wireless communication device 700 described and illustrated in connection with FIG. 7. In some examples, the process 1100 may be carried out by any suitable apparatus or means for carrying out the functions or algorithms described herein.

At block 1102, a UE may be identified, where the UE may be associated with at least two timing advance groups (TAGs), where any of the at least two TAGs that has a special cell (SpCell) is designated as a primary-timing advance group (P-TAG), and the other TAG may be designated as a secondary-timing advance group (S-TAG). In some examples, at least one of the at least two TAGS is the P-TAG. For example, the communications and processing circuitry 741, shown and described above in connection with FIG. 7, may provide a means for identifying a UE, where the UE may be associated with at least two timing advance groups (TAGs), where any of the at least two TAGs that has a special cell (SpCell) is designated as a primary-timing advance group (P-TAG), and the other TAG may be designated as a secondary-timing advance group (S-TAG).

At block 1104, the UE may determine if a serving cell is a secondary cell (SCell) of the S-TAG and the serving cell is other than the SpCell. For example, the communications and processing circuitry 741, shown and described above in connection with FIG. 7, may provide a means for determining if a serving cell is a secondary cell (SCell) of the S-TAG and the serving cell is other than the SpCell. If the UE determines that the serving cell is a secondary cell (SCell) of the S-TAG and the serving cell is other than the SpCell, then the process may advance to block 1106.

At block 1106, the UE may release at least one of: a physical uplink control channel (PUCCH), a physical uplink shared channel (PUSCH), or a sounding reference signal (SRS) for the at least one of cells or TRPs of the at least one of the at least two TAGs that is associated with the one timeAlignmentTimer, in response to an expiration of the one timeAlignmentTimer. For example, the release circuitry 742, shown and described above in connection with FIG. 7, may provide a means for releasing, where the serving cell is a secondary cell (SCell) of the S-TAG and the serving cell is other than the SpCell, the at least the one of: the PUCCH, the PUSCH, or the SRS for the at least one of cells or TRPs of the at least one of the at least two TAGs that is associated with the one timeAlignmentTimer, in response to an expiration of the one timeAlignmentTimer. Thereafter the process 1100 may end.

Returning to block 1104, if the UE determines that the serving cell is not a secondary cell (SCell) of the S-TAG and the serving cell is the SpCell, then the process may advance to block 1108.

At block 1108, the UE may determine if the serving cell is the SpCell and the SpCell has only one TAG and one associated timeAlignmentTimer. For example, the communications and processing circuitry 741, shown and described above in connection with FIG. 7, may provide a means for determining if the serving cell is the SpCell and the SpCell has only one TAG and one associated timeAlignmentTimer. If the serving cell is the SpCell and the SpCell has only one TAG and one associated timeAlignmentTimer, the process may advance to block 1110, otherwise, the process 1100 may advance to block 1112.

At block 1110, the UE may release the at least one of: the PUCCH, the PUSCH, or the SRS for all of the at least one of cells or TRPs associated with the only one TAG that are in the same cell group, in response to the one associated timeAlignmentTimer being expired. For example, the release circuitry 742, shown and described above in connection with FIG. 7, may provide a means for releasing the at least one of: the PUCCH, the PUSCH, or the SRS for all of the at least one of cells or TRPs associated with the only one TAG that are in the same cell group, in response to the one associated time AlignmentTimer being expired. Thereafter, the process 1100 may end.

At block 1112, the UE may determine if a first TAG of the at least two TAGs is the P-TAG and a second TAG of the at least two TAGs is the S-TAG. For example, the communications and processing circuitry 741, shown and described above in connection with FIG. 7, may provide a means for determining if a first TAG of the at least two TAGs is the P-TAG and a second TAG of the at least two TAGs is the S-TAG. If the first TAG of the at least two TAGs is the P-TAG and a second TAG of the at least two TAGs is the S-TAG, the process 1100 may advance to block 1114. If the first TAG of the at least two TAGs is not the P-TAG and the second TAG of the at least two TAGs is not the S-TAG, the process 1100 may end.

At block 1114, the UE may determine if the serving cell is the SpCell and if a first timeAlignmentTimer of the P-TAG expired. For example, the timeAlignmentTimer circuitry 743, shown and described above in connection with FIG. 7, may provide a means for determining if the serving cell is the SpCell and if a first timeAlignmentTimer of the P-TAG expired. If the serving cell is the SpCell and if the first timeAlignmentTimer of the P-TAG is expired, the UE may, at block 1116, release the at least one of: the PUCCH, the PUSCH, or the SRS for all of the at least one of cells or TRPs associated with the first TAG that are in a same cell group. For example, the release circuitry 742, shown and described above in connection with FIG. 7, may provide a means for releasing the at least one of: the PUCCH, the PUSCH, or the SRS for all of the at least one of cells or TRPs associated with the first TAG that are in a same cell group. If, at block 1114, the serving cell is not the SpCell and if the first timeAlignmentTimer of the P-TAG is not expired, the process 1100 may advance to block 1118.

At block 1118, the UE may determine if the serving cell is the SpCell and if a second timeAlignmentTimer of the S-TAG is expired. For example, the time AlignmentTimer circuitry 743, shown and described above in connection with FIG. 7, may provide a means for determining if the serving cell is the SpCell and if a second time AlignmentTimer of the S-TAG is expired. If the serving cell is the SpCell and if the second timeAlignmentTimer of the S-TAG is expired, the UE, at block 1120, may release the at least one of: the PUCCH, the PUSCH, or the SRS: for any single-TAG cell or any TRP in a two-TAG cell that uses a same S-TAG; for any cell, including the SpCell, comprising the same S-TAG; or for any cell or any TRP in a same cell group. For example, the release circuitry 742, shown and described above in connection with FIG. 7, may provide a means for releasing the at least one of: the PUCCH, the PUSCH, or the SRS: for any single-TAG cell or any TRP in a two-TAG cell that uses a same S-TAG; for any cell, including the SpCell, comprising the same S-TAG; or for any cell or any TRP in a same cell group. If, at block 1118, the UE determines that the serving cell is not the SpCell and determines that the second timeAlignmentTimer of the S-TAG is not expired, the process 1000 may end. In some examples, in addition to the releasing the at least one of: the PUCCH, the PUSCH, or the SRS for any TRP in the two-TAG cell that uses the same S-TAG, the UE may further identify one or more hybrid automatic repeat request identifiers (HARQ IDs) having a scheduling control resource set pool index (CORESETPoolIndex) that matches the scheduling CORESETPoolIndex associated with an expired timeAlignmentTimer associated with the S-TAG, and may flush HARQ buffers corresponding to the one or more HARQ IDs. For example, the timeAlignmentTimer circuitry 743, shown and described above in connection with FIG. 7, may provide a means for identifying one or more hybrid automatic repeat request identifiers (HARQ IDs) having a scheduling control resource set pool index (CORESETPoolIndex) that matches the scheduling CORESETPoolIndex associated with an expired timeAlignmentTimer associated with the S-TAG, and a means for flushing HARQ buffers corresponding to the one or more HARQ IDs.

According to some examples, when both of the at least two TAGs are P-TAGS, the UE may release the at least one of: the PUCCH, the PUSCH, or the SRS for all of the at least one of cells or TRPs associated with an expired timeAlignmentTimer that are in the same cell group, in response to the serving cell being the SpCell and the timeAlignmentTimer being expired. For example, the release circuitry 742, shown and described above in connection with FIG. 7, may provide a means for releasing the at least one of: PUCCH, the PUSCH, or the SRS for all of the at least one of cells or TRPs associated with an expired timeAlignmentTimer that are in the same cell group.

According to another example, when at least one of the at least two TAGs is the S-TAG, the UE may further release the at least one of: the PUCCH, the PUSCH, or the SRS for all of at least one of single-TAG cells or two-TAG cells that use the same S-TAG, in response to the serving cell being the SpCell and a timeAlignmentTimer of the at least one of the at least two TAGs being expired. For example, the timeAlignmentTimer circuitry 743, shown and described above in connection with FIG. 7, may provide a means for releasing the at least one of: the PUCCH, the PUSCH, or the SRS for all of at least one of single-TAG cells or two-TAG cells that use the same S-TAG, in response to the serving cell being the SpCell and a timeAlignmentTimer of the at least one of the at least two TAGs being expired. According to such an example, for any TRP in the two-TAG cells that uses the same S-TAG, the UE may further identify one or more hybrid automatic repeat request identifiers (HARQ IDs) having a scheduling control resource set pool index (CORESETPoolIndex) that matches the scheduling CORESETPoolIndex associated with an expired timeAlignmentTimer associated with the S-TAG, and flush HARQ buffers corresponding to the one or more HARQ IDs.

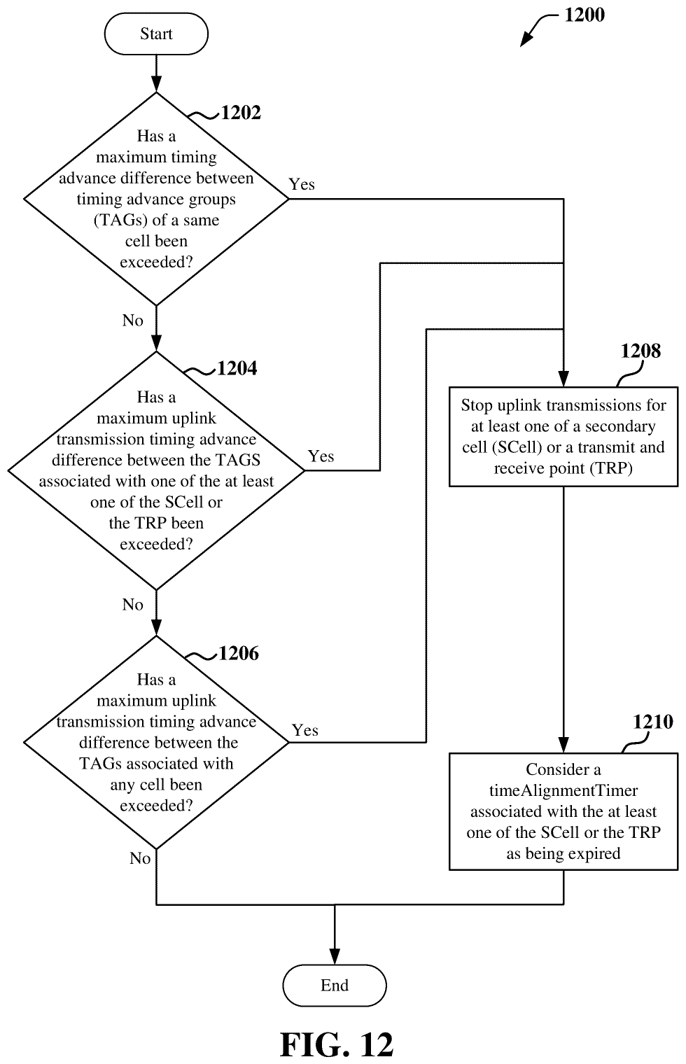

FIG. 12 is a flow chart illustrating an exemplary process 1200 (e.g., a method of wireless communication) at a user equipment (UE) (e.g., at a wireless communication device, at a scheduled entity) according to some aspects of the disclosure. The process 1200 may occur in a wireless communication network, such as the wireless communication networks of FIGS. 1 and/or 2, for example. As described below, some or all illustrated features may be omitted in a particular implementation within the scope of the present disclosure, and some illustrated features may not be required for all implementations. In some examples, the process 1200 may be carried out by the wireless communication device 700 described and illustrated in connection with FIG. 7. In some examples, the process 1200 may be carried out by any suitable apparatus or means for carrying out the functions or algorithms described herein.

At block 1202, the UE may determine if a maximum timing advance difference between timing advance groups (TAGs) of a same cell has been exceeded. If the maximum has not been exceeded, the UE, at block 1204, may determine if a maximum uplink transmission timing advance difference between the TAGS associated with one of the at least one of the SCell or the TRP has been exceeded. If the maximum has not been exceeded, the UE, at block 1206, may determine if a maximum uplink transmission timing advance difference between the TAGs associated with any cell has been exceeded. If the maximum uplink transmission timing advance difference between the TAGs associated with any cell has not been exceeded, the process 1200 may end. However, if at any of block 1202, block 1204, or block 1206 the tested maximum was exceeded, then, at block 1208, the UE may stop uplink transmissions for at least one of a secondary cell (SCell) or a transmit and receive point (TRP). Thereafter, at block 1210, the UE may consider a timeAlignmentTimer associated with the at least one of the SCell or the TRP as being expired. Thereafter, the process 1200 may end. For example, the communications and processing circuitry 741, shown and described above in connection with FIG. 7, may provide a means for determining if a maximum timing advance difference between timing advance groups (TAGs) of a same cell has been exceeded. The communications and processing circuitry 741 may also provide a means for determining if a maximum uplink transmission timing advance difference between the TAGS associated with one of the at least one of the SCell or the TRP has been exceeded. The communications and processing circuitry 741 may also provide a means for determining if a maximum uplink transmission timing advance difference between the TAGs associated with any cell has been exceeded. Still further the communications and processing circuitry 741 may also provide a means for stopping uplink transmissions for at least one of a secondary cell (SCell) or a transmit and receive point (TRP). By way of further example, the timeAlignmentTimer circuitry 744, shown and described above in connection with FIG. 7, may provide a means for considering a timeAlignmentTimer associated with the at least one of the SCell or the TRP as being expired.

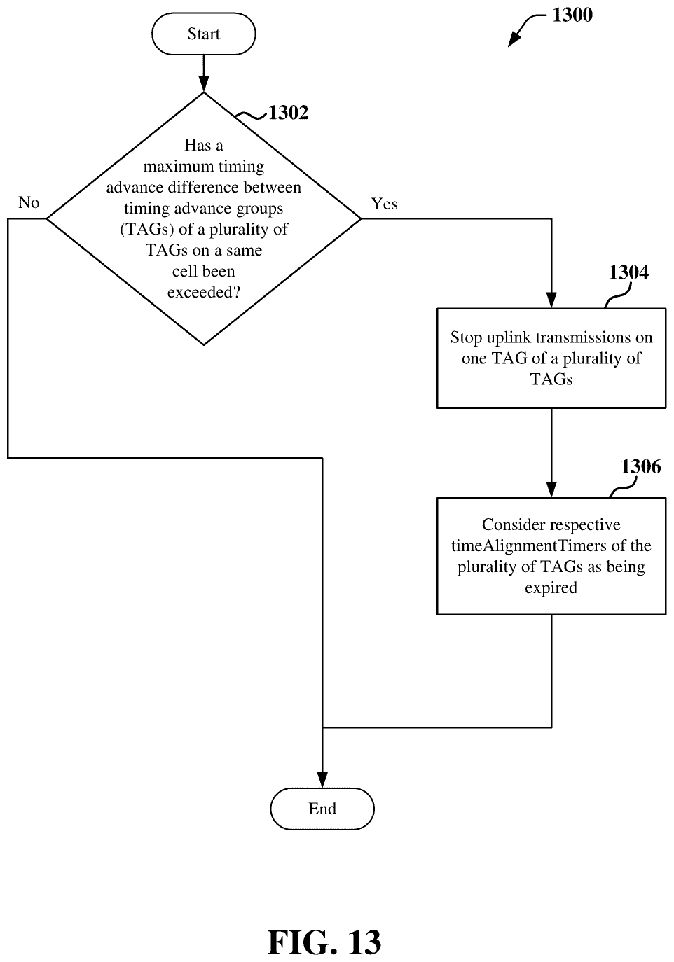

FIG. 13 is a flow chart illustrating an exemplary process 1300 (e.g., a method of wireless communication) at a user equipment (UE) (e.g., at a wireless communication device, at a scheduled entity) according to some aspects of the disclosure. The process 1300 may occur in a wireless communication network, such as the wireless communication networks of FIGS. 1 and/or 2, for example. As described below, some or all illustrated features may be omitted in a particular implementation within the scope of the present disclosure, and some illustrated features may not be required for all implementations. In some examples, the process 1300 may be carried out by the wireless communication device 700 described and illustrated in connection with FIG. 7. In some examples, the process 1300 may be carried out by any suitable apparatus or means for carrying out the functions or algorithms described herein.

At block 1302, the UE may determine if a maximum timing advance difference between timing advance groups (TAGs) of a plurality of TAGs on a same cell has been exceeded. If the maximum has not been exceeded, the process 1300 may end. However, if at any of block 1302 the tested maximum was exceeded, then, at block 1304, the UE may stop uplink transmissions on one TAG of the plurality of TAGs. Thereafter, at block 1306, the UE may consider respective timeAlignmentTimers of the plurality of TAGs as being expired. Thereafter, the process 1300 may end. For example, the timeAlignmentTimer circuitry 744, shown and described above in connection with FIG. 7, may provide a means for determining if a maximum timing advance difference between timing advance groups (TAGs) of a plurality of TAGs on a same cell has been exceeded. The timeAlignmentTimer circuitry 744 may also provide a means for stopping uplink transmissions on one TAG of the plurality of TAGs. Still further the timeAlignmentTimer circuitry 744 may also provide a means for considering respective timeAlignmentTimers of the plurality of TAGs as being expired. According to one aspect, the one timing advance group (TAG) is at least one of: a lower TAG identifier (TAG ID), a larger timing advance (TA) value, or a TAG associated with control resource set pool index (CORESETPoolIndex) 0.

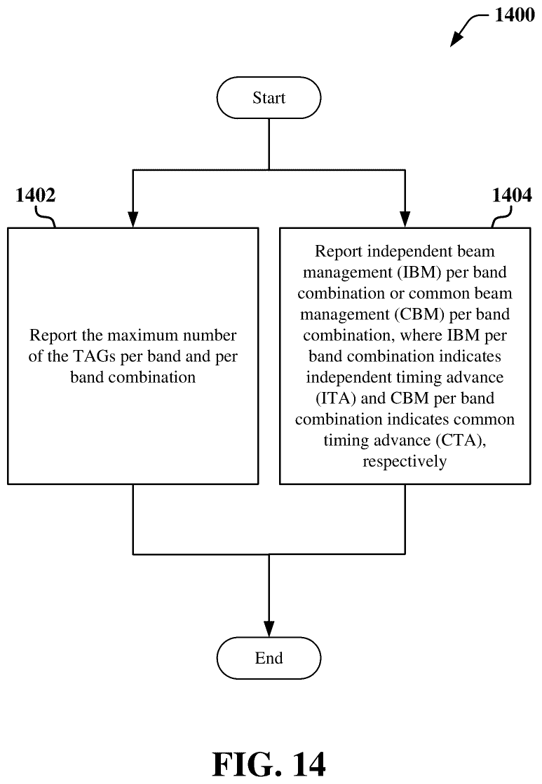

FIG. 14 is a flow chart illustrating an exemplary process 1400 (e.g., a method of wireless communication) at a user equipment (UE) (e.g., at a wireless communication device, at a scheduled entity) according to some aspects of the disclosure. The process 1400 may occur in a wireless communication network, such as the wireless communication networks of FIGS. 1 and/or 2, for example. As described below, some or all illustrated features may be omitted in a particular implementation within the scope of the present disclosure, and some illustrated features may not be required for all implementations. In some examples, the process 1400 may be carried out by the wireless communication device 700 described and illustrated in connection with FIG. 7. In some examples, the process 1400 may be carried out by any suitable apparatus or means for carrying out the functions or algorithms described herein.

In connection with the process 1400, a user equipment (UE) having a first capability to operate on at least a first set of component carriers or a second set of bands that share a common set of timing advance groups (TAGs) and operate with a maximum number of the TAGs in the common set of TAGs is introduced. At block 1402, the UE may report the maximum number of the TAGs per band and per band combination. For example, the communication and processing circuitry 741, shown and described in connection with FIG. 7, may provide a means for reporting the maximum number of the TAGs per band and per band combination. The UE may report in a UE capability report on a set of CCs or bands (or both) sharing a common set of TAGs and maximum number of TAGs in the common set. Alternatively, at block 1404, the UE may report independent beam management (IBM) per band combination or common beam management (CBM) per band combination, wherein IBM per band combination indicates independent timing advance (ITA) and CBM per band combination indicates common timing advance (CTA), respectively. For example, the communication and processing circuitry 741, shown and described in connection with FIG. 7, may provide a means for reporting independent beam management (IBM) per band combination or common beam management (CBM) per band combination, where IBM per band combination indicates independent timing advance (ITA) and CBM per band combination indicates common timing advance (CTA), respectively.

Of course, in the above examples, the circuitry included in the processor 704 merely provided as an example. Other means for carrying out the described processes or functions may be included within various aspects of the present disclosure, including but not limited to the instructions stored in the computer-readable medium 710 or any other suitable apparatus or means described in any one of the FIGS. 1, 3, 4, 5, 6, and/or 7 and utilizing, for example, the processes and/or algorithms described herein in relation to FIGS. 8, 9, 10, 11A, 11B, 12, 13, and/or 14.

The following provides an overview of aspects of the present disclosure:

Aspect 1: A user equipment (UE) configured for wireless communication, comprising: a processor, and a memory coupled to the processor, wherein the processor and the memory are configured to at least one of: release, in association with a serving cell that is a special cell (SpCell) and has at least two timing advance groups (TAGs) with one time alignment timer (timeAlignmentTimer) of the at least two TAGs being expired, at least one of: a physical uplink control channel (PUCCH), a physical uplink shared channel (PUSCH), or a sounding reference signal (SRS) for at least one of cells or transmission and reception points (TRPs) that share a TAG associated with the one timeAlignmentTimer that is expired; or release, in association with the serving cell that is the SpCell and has the at least two TAGs with two respective timeAlignmentTimers of the at least two TAGs being expired, the at least one of: the PUCCH, the PUSCH, or the SRS for all cells or TRPs that are in a same cell group as the SpCell.

Aspect 2: The UE of aspect 1, wherein a medium access control (MAC) entity of the UE determines to release the at least one of: the PUCCH, the PUSCH, or the SRS and notifies a radio resource control (RRC) entity of the UE to perform the releasing of the at least one of: the PUCCH, the PUSCH, or the SRS.

Aspect 3: The UE of aspect 1 or 2, wherein the SpCell is at least one of: a primary cell (PCell) of a master cell group (MCG), a primary secondary cell (PSCell) of a secondary cell group (SCG), or is otherwise a PCell.

Aspect 4: The UE of any of aspects 1 through 3, wherein the SpCell supports PUCCH transmission and contention-based random access.

Aspect 5: The UE of any of aspects 1 through 4, wherein each of the at least two TAGs are a respective group of serving cells that, for cells with an uplink configured, use a same timing reference cell and a same timing advance value.

Aspect 6: The UE of any of aspects 1 through 5, wherein the processor and the memory are further configured to: identify one or more hybrid automatic repeat request identifiers (HARQ IDs), on a per-TRP basis, having a scheduling control resource set pool index (CORESETPoolIndex) that matches the scheduling CORESETPoolIndex associated with an expired time AlignmentTimer, and flush HARQ buffers corresponding to corresponding to the one or more HARQ IDs.

Aspect 7: The UE of any of aspects 1 through 6, wherein the processor and the memory are further configured to: determine, on a per-TRP basis, one or more to-be-released or to-be-cleared at least one of: the PUCCH, the PUSCH, the SRS, a semi-persistent scheduling (SPS), a configured grant (CG), or a physical uplink shared channel (PUSCH) with semi-persistent-channel state information (SP-CSI) associated with an expired timeAlignmentTimer, and associate a unified transmission configuration indicator (TCI), assigned to a control resource set pool index (CORESETPoolIndex) associated with the expired timeAlignmentTimer, with the determined one or more to-be-released or to-be-cleared at least one of: the PUCCH, the PUSCH, the SRS, the SPS, the CG, or the PUSCH with SP-CSI.

Aspect 8: The UE of any of aspects 1 through 7, wherein any TAG having the SpCell is a primary-timing advance group (P-TAG), and another TAG is a secondary-timing advance group (S TAG).

Aspect 9: A method of wireless communication at a user equipment (UE), comprising at least one of: releasing, in association with a serving cell that is a special cell (SpCell) and has at least two timing advance groups (TAGs) with one time alignment timer (timeAlignmentTimer) of the at least two TAGs being expired, at least one of: a physical uplink control channel (PUCCH), a physical uplink shared channel (PUSCH), or a sounding reference signal (SRS) for at least one of cells or transmission and reception points (TRPs) that share a TAG associated with the one timeAlignmentTimer that is expired; or releasing, in association with the serving cell that is the SpCell and has the at least two TAGs with two respective timeAlignmentTimers of the at least two TAGs being expired, the at least one of: the PUCCH, the PUSCH, or the SRS for all cells or TRPs that are in a same cell group as the SpCell.

Aspect 10: The method of aspect 9, wherein a medium access control (MAC) entity of the UE determines to release the at least one of: the PUCCH, the PUSCH, or the SRS and notifies a radio resource control (RRC) entity of the UE to perform the releasing of the at least one of: the PUCCH, the PUSCH, or the SRS.

Aspect 11: The method of aspect 9 or 10, wherein the SpCell is at least one of: a primary cell (PCell) of a master cell group (MCG), a primary secondary cell (PSCell) of a secondary cell group (SCG), or is otherwise a PCell.

Aspect 12: The method of any of aspects 9 through 11, wherein the SpCell supports PUCCH transmission and contention-based random access.

Aspect 13: The method of any of aspects 9 through 12, wherein each of the at least two TAGs are a respective group of serving cells that, for cells with an uplink configured, use a same timing reference cell and a same timing advance value.

Aspect 14: The method of any of aspects 9 through 13, further comprising: identifying one or more hybrid automatic repeat request identifiers (HARQ IDs), on a per-TRP basis, having a scheduling control resource set pool index (CORESETPoolIndex) that matches the scheduling CORESETPoolIndex associated with an expired timeAlignmentTimer, and flushing HARQ buffers corresponding to corresponding to the one or more HARQ IDs.

Aspect 15: The method of any of aspects 9 through 14, further comprising: determining, on a per-TRP basis, one or more to-be-released or to-be-cleared at least one of: the PUCCH, the PUSCH, the SRS, a semi-persistent scheduling (SPS), a configured grant (CG), or a physical uplink shared channel (PUSCH) with semi-persistent-channel state information (SP-CSI) associated with an expired timeAlignmentTimer, and associating a unified transmission configuration indicator (TCI), assigned to a control resource set pool index (CORESETPoolIndex) associated, with the expired timeAlignmentTimer, with the determined one or more to-be-released or to-be-cleared at least one of: the PUCCH, the PUSCH, the SRS, the SPS, the CG, or the PUSCH with SP-CSI.

Aspect 16: The method of any of aspects 9 through 15, wherein any TAG having the SpCell is a primary-timing advance group (P-TAG), and another TAG is a secondary-timing advance group (S TAG).

Aspect 17: The method of aspect 16, wherein at least one of the at least two TAGS is the P TAG.

Aspect 18: The method of aspect 16 or 17, further comprising: releasing, where the serving cell is a secondary cell (SCell) of the S-TAG and the serving cell is other than the SpCell, the PUCCH and the SRS for the at least one of cells or TRPs of the at least one of the at least two TAGs that is associated with the one timeAlignmentTimer, in response to an expiration of the one timeAlignmentTimer; and releasing, where the serving cell is the SpCell and the SpCell has only one TAG and one associated time AlignmentTimer, the PUCCH and the SRS for all of the at least one of cells or TRPs associated with the only one TAG that are in the same cell group, in response to the one associated timeAlignmentTimer being expired.

Aspect 19: The method of any of aspects 16 through 18, wherein a first TAG of the at least two TAGs is the P-TAG and a second TAG of the at least two TAGs is the S-TAG, the method further comprising: releasing the PUCCH and the SRS for all of the at least one of cells or TRPs associated with the first TAG that are in a same cell group, in response to the serving cell being the SpCell and a first timeAlignmentTimer of the P-TAG being expired; and releasing the PUCCH and the SRS: for any single-TAG cell or any TRP in a two-TAG cell that uses a same S-TAG, for any cell, including the SpCell, comprising the same S-TAG, or for any cell or any TRP in a same cell group, in response to the serving cell being the SpCell and a second timeAlignmentTimer of the S-TAG being expired.

Aspect 20: The method of aspect 19, wherein in addition to the releasing the PUCCH and the SRS for any TRP in the two-TAG cell that uses the same S-TAG, the method further comprising: identifying one or more hybrid automatic repeat request identifiers (HARQ IDs) having a scheduling control resource set pool index (CORESETPoolIndex) that matches the scheduling CORESETPoolIndex associated with an expired timeAlignmentTimer associated with the S-TAG; and flushing HARQ buffers corresponding to the one or more HARQ IDs.

Aspect 21: The method of any of aspects 16 through 20, wherein when both of the at least two TAGs are P-TAGs, the method further comprising: releasing the PUCCH and the SRS for all of the at least one of cells or TRPs associated with an expired timeAlignmentTimer that are in the same cell group, in response to the serving cell being the SpCell and the timeAlignmentTimer being expired.

Aspect 22: The method of any of aspects 16 through 21, wherein at least one of the at least two TAGs is the S-TAG, the method further comprising: releasing the PUCCH and the SRS for all of at least one of single-TAG cells or two-TAG cells that use the same S-TAG, in response to the serving cell being the SpCell and a timeAlignmentTimer of the at least one of the at least two TAGs being expired.

Aspect 23: The method of aspect 22, wherein for any TRP in the two-TAG cells that uses the same S TAG, the method further comprising: identifying one or more hybrid automatic repeat request identifiers (HARQ IDs) having a scheduling control resource set pool index (CORESETPoolIndex) that matches the scheduling CORESETPoolIndex associated with an expired timeAlignmentTimer associated with the S-TAG; and flushing HARQ buffers corresponding to the one or more HARQ IDs.

Aspect 24: An apparatus for wireless communication, comprising at least one of: means for releasing, in association with a serving cell that is a special cell (SpCell) and has at least two timing advance groups (TAGs) with one time alignment timer (timeAlignmentTimer) of the at least two TAGs being expired, at least one of: a physical uplink control channel (PUCCH), a physical uplink shared channel (PUSCH), or a sounding reference signal (SRS) for at least one of cells or transmission and reception points (TRPs) that share a TAG associated with the one timeAlignmentTimer that is expired; or means for releasing, in association with the serving cell that is the SpCell and has the at least two TAGs with two respective timeAlignmentTimers of the at least two TAGs being expired, the at least one of: the PUCCH, the PUSCH, or the SRS for all cells or TRPs that are in a same cell group as the SpCell.

Aspect 25: The apparatus of aspect 24, wherein a medium access control (MAC) entity of the UE determines to release the at least one of: the PUCCH, the PUSCH, or the SRS and notifies a radio resource control (RRC) entity of the UE to perform the releasing of the at least one of: the PUCCH, the PUSCH, or the SRS.

Aspect 26: The apparatus of aspect 24 or 25, wherein the SpCell is at least one of: a primary cell (PCell) of a master cell group (MCG), a primary secondary cell (PSCell) of a secondary cell group (SCG), or is otherwise a PCell.

Aspect 27: The apparatus of any of aspects 24 through 26, wherein the SpCell supports PUCCH transmission and contention-based random access.

Aspect 28: A method of wireless communication at a user equipment (UE), comprising: stopping uplink transmissions for at least one of a secondary cell (SCell) or a transmit and receive point (TRP) in response to exceeding at least one of: a maximum timing advance difference between timing advance groups (TAGs) of a same cell, a maximum uplink transmission timing advance difference between the TAGS associated with one of the at least one of the SCell or the TRP, or a maximum uplink transmission timing advance difference between the TAGs associated with any cell; and considering a timeAlignmentTimer associated with the at least one of the SCell or the TRP as being expired.

Aspect 29: A method of wireless communication at a user equipment (UE), comprising: stopping uplink transmission on one timing advance group (TAG) of a plurality of TAGs in response to exceeding a maximum timing advance difference between TAGs of the plurality of TAGs on the same cell; and considering respective time AlignmentTimers of the plurality of TAGs as being expired.

Aspect 30: The method of aspect 29, wherein the one timing advance group (TAG) is at least one of: a lower TAG identifier (TAG ID), a larger timing advance (TA), or a TAG associated with control resource set pool index (CORESETPoolIndex) 0.

Aspect 31: A method of wireless communication at a user equipment (UE) having a first capability to operate on at least a first set of component carriers or a second set of bands that share a common set of timing advance groups (TAGs) and operate with a maximum number of the TAGs in the common set of TAGs, comprising at least one of: reporting the maximum number of the TAGs per band or per band combination, or reporting independent beam management (IBM) per band combination or common beam management (CBM) per band combination, wherein IBM or CBM per band combination indicates independent timing advance (ITA) or common timing advance (CTA), respectively.

Aspect 32: A user equipment (UE) configured for wireless communication comprising a processor, and a memory coupled to the processor, the processor and memory configured to perform a method of any one of aspects 9 through 23 or 28 through 31.

Aspect 33: An apparatus configured for wireless communication comprising at least one means for performing a method of any one of aspects 9 through 23 or 28 through 31.

Aspect 34: A non-transitory computer-readable medium storing computer-executable code, comprising code for causing an apparatus to perform a method of any one of aspects 9 through 23 or 28 through 31.

Several aspects of a wireless communication network have been presented with reference to an exemplary implementation. As those skilled in the art will readily appreciate, various aspects described throughout this disclosure may be extended to other telecommunication systems, network architectures and communication standards.

By way of example, various aspects may be implemented within other systems defined by 3GPP, such as Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA 2000 and/or Evolution-Data Optimized (EV-DO). Other examples may be implemented within systems employing IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage, or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in FIGS. 1-14 may be rearranged and/or combined into a single component, step, feature, or function or embodied in several components, steps, or functions. Additional elements, components, steps, and/or functions may also be added without departing from novel features disclosed herein. The apparatus, devices, and/or components illustrated in FIGS. 1-14 may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order and are not meant to be limited to the specific order or hierarchy presented unless specifically recited therein. While some examples illustrated herein depict only time and frequency domains, additional domains such as a spatial domain are also contemplated in this disclosure.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. The construct A and/or B is intended to cover: A; B; and A and B. The word “obtain” as used herein may mean, for example, acquire, calculate, construct, derive, determine, receive, and/or retrieve. The preceding list is exemplary and not limiting. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

1. A user equipment (UE) configured for wireless communication, comprising:
one or more processors; and
one or more memories coupled to the one or more processors, wherein the one or more processors are configured to at least one of:
release, in association with a serving cell that is a special cell (SpCell) and has at least two timing advance groups (TAGs) with one time alignment timer (timeAlignmentTimer) of the at least two TAGs being expired, at least one of: a physical uplink control channel (PUCCH), a physical uplink shared channel (PUSCH), or a sounding reference signal (SRS) for at least one of cells or transmission and reception points (TRPs) that share a TAG associated with the one timeAlignmentTimer that is expired; or
release, in association with the serving cell that is the SpCell and has the at least two TAGs with two respective timeAlignmentTimers of the at least two TAGs being expired, the at least one of: the PUCCH, the PUSCH, or the SRS for all cells or TRPs that are in a same cell group as the SpCell.

2. The UE of claim 1, wherein a medium access control (MAC) entity of the UE determines to release the at least one of: the PUCCH, the PUSCH, or the SRS and notifies a radio resource control (RRC) entity of the UE to perform the releasing of the at least one of: the PUCCH, the PUSCH, or the SRS.

3. The UE of claim 1, wherein the SpCell is at least one of:
a primary cell (PCell) of a master cell group (MCG),
a primary secondary cell (PSCell) of a secondary cell group (SCG), or
is otherwise a PCell.

4. The UE of claim 1, wherein the SpCell supports PUCCH transmission and contention-based random access.

5. The UE of claim 1, wherein each of the at least two TAGs are a respective group of serving cells that, for cells with an uplink configured, use a same timing reference cell and a same timing advance value.

6. The UE of claim 1, wherein the one or more processors are further configured to:
identify one or more hybrid automatic repeat request identifiers (HARQ IDs), on a per-TRP basis, having a scheduling control resource set pool index (CORESETPoolIndex) that matches the scheduling CORESETPoolIndex associated with an expired timeAlignmentTimer; and
flush HARQ buffers corresponding to the one or more HARQ IDs.

7. The UE of claim 1, wherein the one or more processors are further configured to:
determine, on a per-TRP basis, one or more to-be-released or to-be-cleared at least one of: the PUCCH, the PUSCH, the SRS, a semi-persistent scheduling (SPS), a configured grant (CG), or the PUSCH with semi-persistent-channel state information (SP-CSI) associated with an expired timeAlignmentTimer; and
associate a unified transmission configuration indicator (TCI), assigned to a control resource set pool index (CORESETPoolIndex) associated with the expired timeAlignmentTimer, with the determined one or more to-be-released or to-be-cleared at least one of: the PUCCH, the PUSCH, the SRS, the SPS, the CG, or the PUSCH with SP-CSI.

8. The UE of claim 1, wherein any TAG having the SpCell is a primary-timing advance group (P-TAG), and another TAG is a secondary-timing advance group (S TAG).

9. A method of wireless communication at a user equipment (UE), comprising at least one of:
releasing, in association with a serving cell that is a special cell (SpCell) and has at least two timing advance groups (TAGs) with one time alignment timer (timeAlignmentTimer) of the at least two TAGs being expired, at least one of: a physical uplink control channel (PUCCH), a physical uplink shared channel (PUSCH), or a sounding reference signal (SRS) for at least one of cells or transmission and reception points (TRPs) that share a TAG associated with the one timeAlignmentTimer that is expired; or
releasing, in association with the serving cell that is the SpCell and has the at least two TAGs with two respective timeAlignmentTimers of the at least two TAGs being expired, the at least one of: the PUCCH, the PUSCH, or the SRS for all cells or TRPs that are in a same cell group as the SpCell.

10. The method of claim 9, wherein a medium access control (MAC) entity of the UE determines to release the at least one of: the PUCCH, the PUSCH, or the SRS and notifies a radio resource control (RRC) entity of the UE to perform the releasing of the at least one of: the PUCCH, the PUSCH, or the SRS.

11. The method of claim 9, wherein the SpCell is at least one of:
a primary cell (PCell) of a master cell group (MCG),
a primary secondary cell (PSCell) of a secondary cell group (SCG), or
is otherwise a PCell.

12. The method of claim 9, wherein the SpCell supports PUCCH transmission and contention-based random access.

13. The method of claim 9, wherein each of the at least two TAGs are a respective group of serving cells that, for cells with an uplink configured, use a same timing reference cell and a same timing advance value.

14. The method of claim 9, further comprising:
identifying one or more hybrid automatic repeat request identifiers (HARQ IDs), on a per-TRP basis, having a scheduling control resource set pool index (CORESETPoolIndex) that matches the scheduling CORESETPoolIndex associated with an expired timeAlignmentTimer; and
flushing HARQ buffers corresponding to the one or more HARQ IDs.

15. The method of claim 9, further comprising:
determining, on a per-TRP basis, one or more to-be-released or to-be-cleared at least one of: the PUCCH, the PUSCH, the SRS, a semi-persistent scheduling (SPS), a configured grant (CG), or the PUSCH with semi-persistent-channel state information (SP-CSI) associated with an expired timeAlignmentTimer; and
associating a unified transmission configuration indicator (TCI), assigned to a control resource set pool index (CORESETPoolIndex) associated with the expired timeAlignmentTimer, with the determined one or more to-be-released or to-be-cleared at least one of: the PUCCH, the PUSCH, the SRS, the SPS, the CG, or the PUSCH with SP-CSI.

16. The method of claim 9, wherein any TAG having the SpCell is a primary-timing advance group (P-TAG), and another TAG is a secondary-timing advance group (S TAG).

17. An apparatus for wireless communication, comprising at least one of:
means for releasing, in association with a serving cell that is a special cell (SpCell) and has at least two timing advance groups (TAGs) with one time alignment timer (timeAlignmentTimer) of the at least two TAGs being expired, at least one of: a physical uplink control channel (PUCCH), a physical uplink shared channel (PUSCH), or a sounding reference signal (SRS) for at least one of cells or transmission and reception points (TRPs) that share a TAG associated with the one timeAlignmentTimer that is expired; or
means for releasing, in association with the serving cell that is the SpCell and has the at least two TAGs with two respective timeAlignmentTimers of the at least two TAGs being expired, the at least one of: the PUCCH, the PUSCH, or the SRS for all cells or TRPs that are in a same cell group as the SpCell.

18. The apparatus of claim 17, wherein a medium access control (MAC) entity of the apparatus determines to release the at least one of: the PUCCH, the PUSCH, or the SRS and notifies a radio resource control (RRC) entity of the apparatus to perform the releasing of the at least one of: the PUCCH, the PUSCH, or the SRS.

19. The apparatus of claim 17, wherein the SpCell is at least one of:
a primary cell (PCell) of a master cell group (MCG),
a primary secondary cell (PSCell) of a secondary cell group (SCG), or
is otherwise a PCell.

20. The apparatus of claim 17, wherein the SpCell supports PUCCH transmission and contention-based random access.
